(19) United States
(12) Patent Application Publication
(10) Pub. No.: US 2015/0112728 A1
(43) Pub. Date: Apr. 23, 2015

(54) MANAGING A RISK OF A LIABILITY THAT IS INCURRED IF ONE OR MORE INSURERS DENIES COVERAGE FOR TREATING ONE OR MORE INSURED FOR ONE OR MORE CONDITIONS

(71) Applicant: Elwha LLC, Bellevue, WA (US)

(72) Inventors: Michael H. BAYM, Cambridge, MA (US); Philip A. ECKHOFF, Kirkland, WA (US); Roderick A. HYDE, Redmond, WA (US); Muriel Y. ISHIKAWA, Livermore, CA (US); Edward K.Y. JUNG, Las Vegas, NV (US); Jordin T. KARE, Seattle, WA (US); Eric C. LEUTHARDT, St. Louis, MO (US); Gary L. MCKNIGHT, Bothell, WA (US); Tony S. PAN, Cambridge, MA (US); Clarence T. TEGREENE, Mercer Island, WA (US); Lowell L. WOOD, JR., Bellevue, WA (US); Victoria Y.H. WOOD, Livermore, CA (US)

(73) Assignee: Elwha LLC, Bellevue, WA (US)

(21) Appl. No.: 14/056,236

(22) Filed: Oct. 17, 2013

(51) Int. Cl. G06Q 40/08

(52) U.S. Cl. CPC G06Q 40/08
USPC 705/4

(57) ABSTRACT

An embodiment of a risk-management method includes determining a risk that one or more insurers will deny coverage for treating one or more insured for one or more conditions, and calculating, in response to a determined risk, a fee for taking a respective action for each instance of at least one of the one or more insurers denying coverage for treating at least one of the one or more insured. Such an embodiment may aid in managing a risk of a liability that may be incurred if one or more insurers under one or more medical insurance policies deny coverage for treating one or more insured under the one or more polices. An example of such liability includes money owing to one or more physicians or other treatment providers that treated the one or more insured (or, from a treatment provider's perspective, the inability to collect such money owing).

If an Application Data Sheet (ADS) has been filed on the filing date of this application, it is incorporated by reference herein. Any applications claimed on the ADS for priority under 35 U.S.C. §§119, 120, 121, or 365(c), and any and all parent, grandparent, great-grandparent, etc. applications of such applications, are also incorporated by reference, including any priority claims made in those applications and any material incorporated by reference, to the extent such subject matter is not inconsistent herewith.

### CROSS-REFERENCE TO RELATED APPLICATIONS

The present application is related to and/or claims the benefit of the earliest available effective filing date(s) from the following listed application(s) (the “Priority Applications”), if any, listed below (e.g., claims earliest available priority dates for other than provisional patent applications or claims benefits under 35 USC §119(e) for provisional patent applications, for any and all parent, grandparent, great-grandparent, etc. applications of the Priority Application(s)). In addition, the present application is related to the “Related Applications,” if any, listed below.

### RELATED APPLICATIONS

U.S. patent application Ser. No. 13/956,128, titled MANAGING A RISK OF A LIABILITY THAT IS INCURRED IF A SUBJECT TREATED FOR A CONDITION IS RETREATED WITHIN A SPECIFIED TIME PERIOD, naming Grace Hsu Huynh, Roderick A. Hyde, Eric C. Leuthardt, Tony S. Pan, Lowell L. Wood, Jr. as inventors, filed 31 Jul. 2013, is related to the present application.
U.S. patent application Ser. No. 13/956,146, titled MANAGING A RISK OF A LIABILITY THAT IS INCURRED IF ONE OR MORE SUBJECTS EACH TREATED FOR A RESPECTIVE CONDITION ARE RETREATED WITHIN A RESPECTIVE SPECIFIED TIME PERIOD, naming Grace Hsu Huynh, Roderick A. Hyde, Eric C. Leuthardt, Tony S. Pan, Lowell L. Wood, Jr. as inventors, filed 31 Jul. 2013, is related to the present application.
U.S. patent application Ser. No. 13/956,157, titled GENERATING A DESCRIPTION OF, AND AN OFFER TO TRANSFER OR A SOLICITATION OF AN OFFER TO ACQUIRE, AN ASSET THAT INCLUDES AT LEAST ONE RETREATMENT CONTRACT, naming Grace Hsu Huynh, Roderick A. Hyde, Eric C. Leuthardt, Tony S. Pan, Lowell L. Wood, Jr. as inventors, filed 31 Jul. 2013, is related to the present application.
U.S. patent application Ser. No. ______, titled MANAGING A RISK OF A LIABILITY THAT IS INCURRED IF AN INSURER DENIES COVERAGE FOR TREATING AN INSURED FOR A CONDITION, naming Michael H. Baym, Philip A. Eckhoff, Roderick A. Hyde, Muriel Y. Ishikawa, Edward K. Y. Jung, Jordin T. Kare, Eric C. Leuthardt, Gary L. McKnight, Tony S. Pan, Clarence T. Tegreene, Lowell L. Wood, Jr., and Victoria Y. H. Wood, as inventors, filed ______ with attorney docket no. 2650-037-03, is related to the present application.

U.S. patent application Ser. No. ______, titled GENERATING A DESCRIPTION OF, AND AN OFFER TO TRANSFER OR A SOLICITATION OF AN OFFER TO ACQUIRE, AN ASSET THAT INCLUDES AT LEAST ONE COVERAGE-DENIAL CONTRACT, naming Michael H. Baym, Philip A. Eckhoff, Roderick A. Hyde, Muriel Y. Ishikawa, Edward K. Y. Jung, Jordin T. Kare, Eric C. Leuthardt, Gary L. McKnight, Tony S. Pan, Clarence T. Tegreene, Lowell L. Wood, Jr., and Victoria Y. H. Wood as inventors, filed ______ with attorney docket no. 2650-041-03, is related to the present application.

If the listings of applications provided above are inconsistent with the listings provided via an ADS, it is the intent of the Applicant to claim priority to each application that appears in the Priority Applications section of the ADS and to each application that appears in the Priority Applications section of this application.

All subject matter of the Priority Applications and the Related Applications and of any and all parent, grandparent, great-grandparent, etc. applications of the Priority Applications and the Related Applications, including any priority claims, is incorporated herein by reference to the extent such subject matter is not inconsistent herewith.

### SUMMARY

The following summary is illustrative only and is not intended to be in any way limiting. In addition to the illustrative aspects, embodiments, and features described above, further aspects, embodiments, and features will become apparent by reference to the drawings and the following detailed description.

An embodiment includes determining a risk that one or more insurers will deny coverage for treating one or more insured for one or more conditions, and calculating, in response to a determined risk, a fee for taking a respective action for each instance of at least one of the one or more insurers denying coverage for treating at least one of the one or more insured.

Such an embodiment may aid in managing a risk of a liability that may be incurred if one or more insurers under one or more medical insurance policies deny coverage for treating one or more insured under the one or more polices.

Examples of such liability include money owing to one or more physicians or other treatment providers that treated the one or more insured (or, from a treatment provider's perspective, the inability to collect money owing), interest on money owing, late fees and other penalties, and a downgrading of the credit of an insured or of a party financially responsible for an insured.

Furthermore, examples of a condition and a treatment include any type of medical condition and suitable treatment therefor.

Moreover, examples of the fee include an insurance premium, and examples of an action include partially or fully reimbursing, e.g., a treatment provider, for the costs incurred for the treatment of an insured, where the treatment is denied by one or more insurers.

In addition, one or more steps of such an embodiment can be performed by a computing apparatus.

### BRIEF DESCRIPTION OF THE FIGURES

FIG. 1 is a diagram of a primary insurance contract, according to an embodiment.

FIG. 2 is a flow diagram of a method for managing a risk that a primary insurer will deny coverage for treating a primary insured for a condition, according to an embodiment.

FIG. 3 is a flow diagram of a method for managing a risk that a primary insurer will deny coverage for treating a primary insured for a condition, according to another embodiment.

FIG. 4 is a diagram of a coverage-denial contract, according to an embodiment.

FIG. 5 is a flow diagram of a method for managing a transfer of a coverage-denial contract, according to an embodiment.

FIG. 6 is a flow diagram of a method for managing a risk that one or more primary insurers will deny coverage for treating one or more primary insured for one or more conditions, according to an embodiment.

FIG. 7 is a flow diagram of a method for managing a risk that one or more primary insurers will deny coverage for treating one or more primary insured for one or more conditions, according to another embodiment.

FIG. 8 is a flow diagram of a method for generating a description of, and an offer to transfer, an asset that includes at least one coverage-denial contract, according to an embodiment.

FIG. 9 is a diagram of an asset that includes at least one coverage-denial contract, such as the coverage-denial contract of FIG. 4, according to an embodiment.

FIG. 10 is a flow diagram of a method for generating a description of, and managing a transfer of, an asset, such as the asset of FIG. 9, according to an embodiment.

FIG. 11 is a flow diagram of a method for forming an asset, such as the asset of FIG. 9, according to an embodiment.

FIG. 12 is a flow diagram of a method for generating a description of an entity that includes an asset, such as the asset of FIG. 9, and for managing a transfer of one or more shares of the entity, according to an embodiment.

FIG. 13 is a diagram of an entity that includes an asset, such as the asset of FIG. 9, according to an embodiment.

FIG. 14 is a diagram of the entity of FIG. 13, and of tranched share classes of the entity, according to an embodiment.

FIG. 15 is a flow diagram of a method for forming an entity, such as one of the entities of FIG. 13 and FIG. 14, according to an embodiment.

FIG. 16 is a block diagram of a computing apparatus that can perform one or more steps of each of the methods described above in conjunction with FIGS. 2-3, 5-8, 10-12, and 15, according to an embodiment.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

One or more embodiments are described with reference to the drawings, wherein like reference numerals may be used to refer to like elements throughout. In the following description, for purposes of explanation, numerous specific details are set forth in order to provide a thorough understanding of the one or more embodiments. It may be evident, however, that one or more embodiments may be practiced without these specific details. In other instances, well-known structures and devices are shown in block-diagram form in order to facilitate describing one or more embodiments.

A typical primary medical insurance policy requires a primary insurer to pay, or reimburse, at least a portion of, the medical expenses that a primary insured incurs for medical treatment that the policy covers. The term “primary” is used to distinguish the insurance policy, insurer, and insured from other contracts, insurers, and insured that are described below.

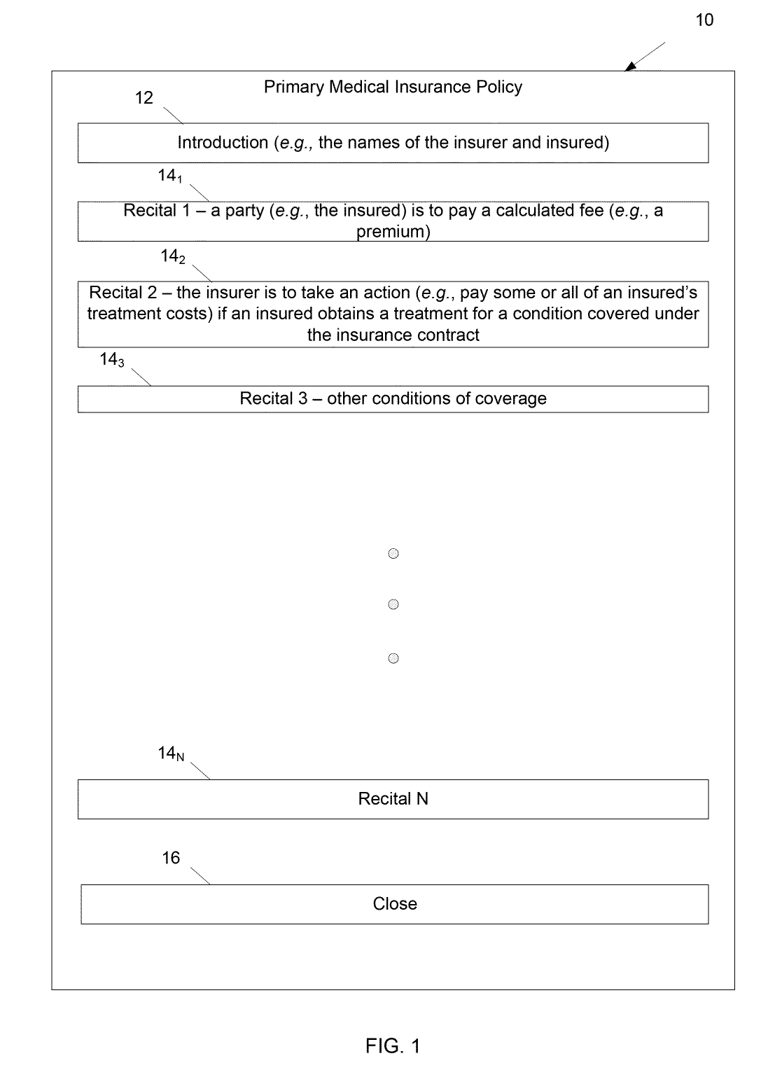

Referring to FIG. 1, a primary medical insurance policy 10 includes an introduction 12, one or more recitals 14, and a close 16, according to an embodiment. The primary insurance policy 10 may be in any suitable form, such as a physical form (e.g., paper) or electronic form (e.g., stored in computer memory, on a magnetic or optical storage disk, on a semiconductor memory “stick,” or on another physical media).

The introduction 12 includes information such as the names and contact information of the primary insurer and primary insured, and definitions of terms used in the policy 10. For example, the primary insurer may be an insurance company (e.g., Aetna, Cigna, Blue Cross) that sells the policy, and the primary insured may be an individual who purchases the policy, and the coverage that it requires the insurer to provide, by paying a periodic (e.g., monthly, annual) insurance premium; alternatively, the insured may acquire the policy through his/her employer, which may pay a partial or entire portion, of each premium on behalf of the insured. The introduction 12 may refer to the primary insured who purchases/acquires the primary policy as the “subscriber,” and may specify other individuals covered under the policy, such as the subscriber's dependents (e.g., spouse, children). Hereinafter, “insured” encompasses a subscriber, or any other party, who is covered, i.e., insured, under an insurance policy or contract.

The recitals 14 include the terms of the primary policy 10. For example, a first recital 14₁ specifies the party (e.g., the subscriber) responsible for paying the fees (e.g., the premiums) due under the primary policy 10. A second recital 14₂ specifies an action (e.g., to pay some or all of a primary insured's medical bill) that the primary insurer must take if an insured obtains treatment for a condition, where both the treatment and the condition are covered under the policy 10. And a third recital 14₃ specifies the conditions and other parameters of the primary policy's coverage, such as, for example, a list and description of covered medical treatments and conditions, a requirement that a primary insured obtain a referral from his/her primary-care physician before receiving a treatment, a requirement that a primary insured use only physicians and other providers within a specified network, a requirement that a primary insured receive pre-approval from the primary insurer before receiving certain specified treatments (e.g., certain specified surgeries or drug therapies), a list of covered prescription drugs, and co-payments that the primary insured must pay for corresponding treatments (e.g., prescription drugs, doctor's office visits). Alternatively, these conditions and other parameters of coverage may be included in multiple recitals 14.

And the close 16 may include the signatures of the parties (e.g., the primary insurer and primary insured) to the primary policy 10, and the period (e.g., a calendar year) during which the policy is effective.

Still referring to FIG. 1, alternate embodiments of the primary insurance policy 10 are contemplated. For example, information described as being located in a portion of the primary policy 10 may be located in another portion of the policy. Furthermore, the primary policy 10 may include information not described above, and may omit information described above. In addition, the order of the recitals 14 may be different than that described above.

To invoke coverage under a primary medical insurance policy, such as the primary policy 10, one typically submits a claim to the primary insurer. For example, a provider that treats a primary insured may submit a completed claim to the primary insurer so that the insurer will pay, directly to the provider, the portion of the provider's fee that the policy requires the insurer to pay.

Unfortunately, under many primary medical insurance policies, the primary insurer is the initial arbiter of whether a submitted claim meets the policy requirements, and whether a particular treatment is otherwise covered under the policy; therefore, an insurer may deny a submitted claim, thus leaving the primary insured (or a party financially responsible for the primary insured) with the burden of paying for a treatment that he/she thought would be covered under his/her medical insurance policy.

Three grounds on which primary medical insurers routinely deny submitted claims are: 1) clerical errors in the submitted claim form, 2) that the primary insured did not comply with a requirement of the primary medical insurance policy, and 3) that the treatment is not covered under the policy.

Examples of clerical errors include a claim being submitted with incomplete (e.g., missing the policy number) or incorrect (e.g., an incorrect treatment or diagnosis code) information; fortunately, claim denials based on clerical errors are often easily reversed by providing the missing or correct information to the primary insurer.

Examples of a primary insured not complying with a policy requirement include the primary insured seeking treatment from an out-of-network provider or failing to obtain a referral from his/her primary-care physician before receiving the treatment for which the claim was submitted. But although such non-compliant claim denials may be more difficult to reverse than claim denials based on clerical errors, it may be relatively easy for the primary insured (or a party responsible for the insured) to prevent such non-compliant claim denials by reading, understanding, and following the terms of the primary insurance policy.

And examples of a treatment being not covered under a primary medical insurance policy include a primary insured receiving a treatment that the primary insurer regards as experimental, medically unnecessary, or otherwise excluded under the terms of the policy. Unfortunately, such treatment-not-covered claim denials may be more difficult to reverse than claim denials based on clerical errors, and may be relatively difficult for a primary insured (or a party responsible for the insured) to prevent because that a primary insurer considers a treatment excluded under a primary policy may not be evident from a reading and understanding of the policy.

One way to reduce the risk that a primary insurer will deny a claim on grounds that a treatment is not covered under a primary insurance policy is to submit a treatment proposal to the insurer for pre-approval before the primary insured receives the treatment.

But submitting a treatment proposal to a primary insurer for pre-approval may not be effective in reducing the risk of a claim denial, and may not always be possible. For example, primary insurers have been known to deny a claim even after pre-approving a treatment proposal. Furthermore, in a life-or-death or other type of emergency situation, there may be insufficient time to seek the primary insurer's treatment pre-approval.

Another way to reduce the risk that a primary insurer will deny a claim on grounds that a treatment is not covered under a primary insurance policy is to study a number of different primary policies, and to purchase a policy that has a lower claim-denial rate as compared to other policies.

The American Medical Association publishes an annual National Health Insurer Report Card (NHIRC), which includes the claim-denial rates (as a percentage of total claims submitted), and a breakdown of the claim-denial grounds, for a number of medical insurers, including Medicare, in their capacities as primary insurers; the NHIRC can be found at http://www.ama-assn.org/ama/pub/physician-resources/practice-management-center/health-insurer-payer-relations/national-health-insurer-reporrt-card/denials.page). For example, the NHIRC indicates that in 2012, among the eight insurers profiled, Anthem had the highest primary-insurance-claim-denial rate of 5.07% of all claims submitted, and Regence had the lowest claim-denial rate of 1.38% of all claims submitted. Furthermore, many states, such as Vermont (http://www.vpirg.org/wp-content/uploads/2013/05/Denied-claims-data-H-HC-4-2-13-final.pdf, http://www.vermontforsinglepayer.org/newdisclosuresshownmvpdenied155percentofpatientclaimsin2012bluecrossdenied76 percent), also publish claim-denial rates and related statistics for primary health insurers.

But the statistical information contained in the NHIRC, and in related publications, indicates that the primary-insurance-claim-denial rates, and the rates of the various grounds for these claim denials, vary significantly among the profiled insurers. For example, during the period 2008-2012, the insurer Aetna denied an average of 3.31% of all primary-insurance claims submitted during a calendar year, and denied 9.59% of these claims on the grounds that Aetna deemed the treatment experimental/investigational. But compare these rates to those of the insurer Cigna, which, during the same period, denied only an average of 1.75% of all primary-insurance claims submitted during a calendar year, and denied only 5.77% of these claims on the grounds that Cigna deemed the treatment experimental/investigational.

Consequently, from the above-described information, and considering that one cannot predict what maladies or other conditions that he/she (or his/her dependents) may suffer in the future, it would be nearly impossible for one to determine which primary medical insurer would be the least likely to deny a claim for an as-of-yet unknown treatment that a primary insured may seek at some unknown time in the future.

And it is anticipated that claim-denial rates of primary medical insurers will only increase as time goes on. For example, medical insurers have started to use sophisticated software tools, dubbed “denial engines,” to analyze submitted claims for the purpose of identifying any and all grounds of denial. Furthermore, medical insurers are just beginning to struggle with the cost-reducing edicts of the Patient Protection and Affordable Care Act (Public Law 111-148), which is commonly referred to as “Obamacare.”

Therefore, described below are embodiments that a party can use to manage its, or another's, risk of incurring a liability if a primary insurer denies a primary insured coverage for a treatment that the insured received. For example, by using an embodiment described herein, a primary insured could manage his/her risk of being “stuck” with a large medical bill if his/her primary insurer denies coverage under his/her primary medical insurance policy for a service or other treatment that the he/she received. Or, a physician, hospital, or other healthcare-treatment provider may use an embodiment described herein to manage its risk of being unable to collect payment from a patient whose primary medical insurer denies coverage for a service or other treatment that the provider administered to the patient. In addition, a primary insured could manage his/her risk of being unable to afford needed treatment if his/her primary insurer denies coverage for the treatment under his/her primary medical insurance policy.

Furthermore, an embodiment described herein may be utilized by parties other than insured individuals and healthcare treatment providers.

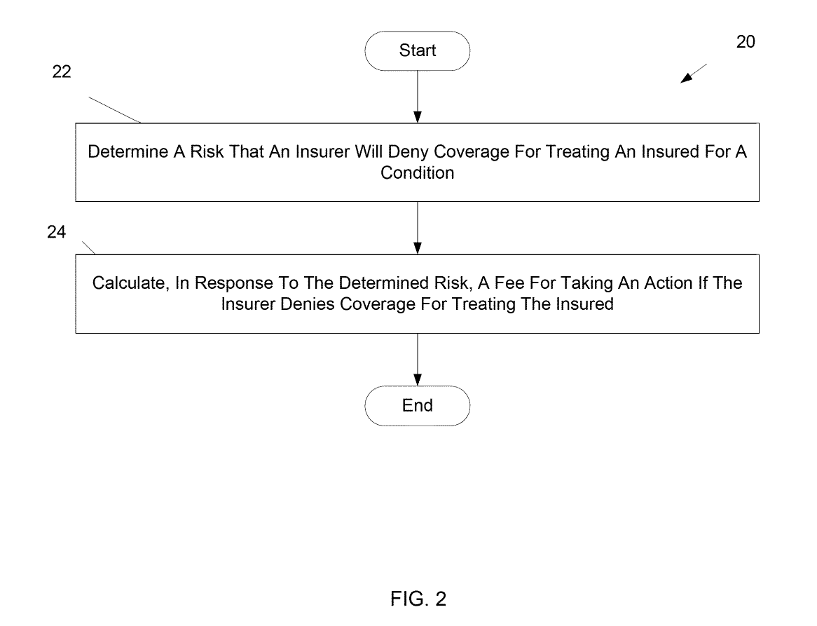

FIG. 2 is a flow diagram 20 of a method for managing a risk that a primary insurer will deny coverage, under a primary medical insurance policy or other contract, for treating a primary insured for a condition, according to an embodiment.

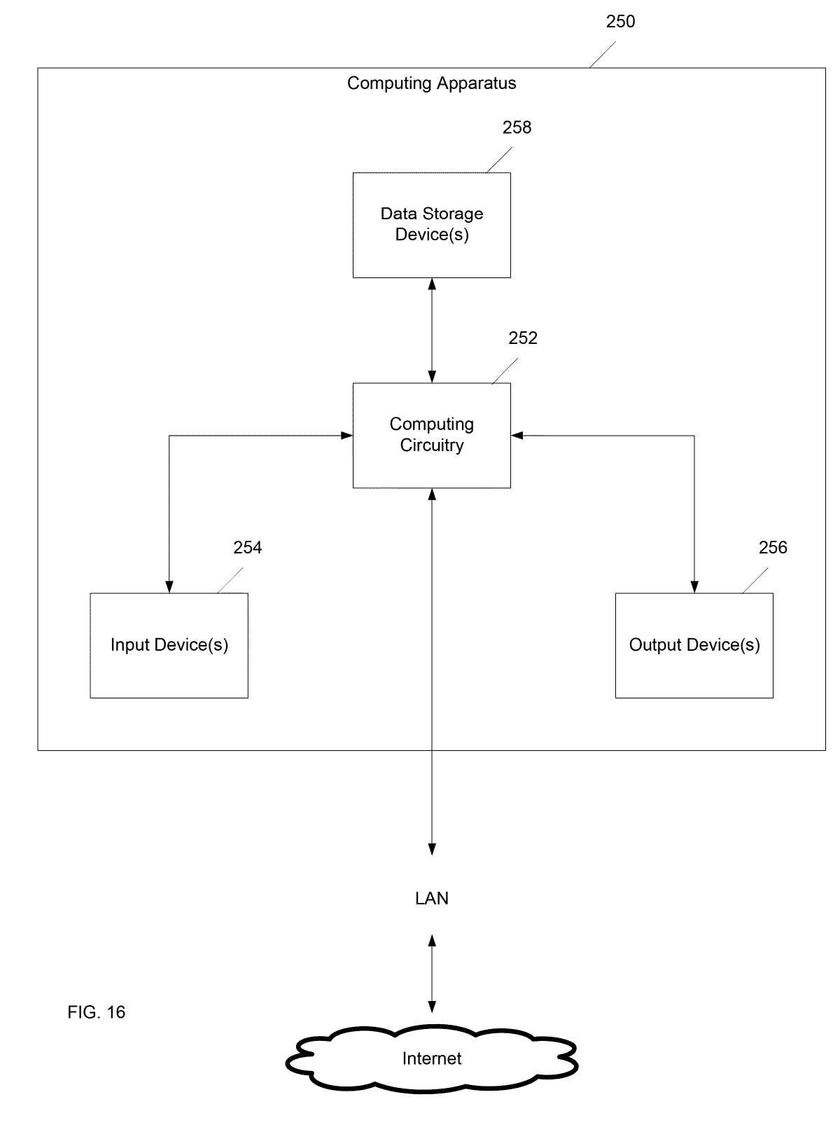

Referring to a step 22, a computing apparatus automatically determines a risk that a primary insurer will deny coverage for treating a primary insured for a condition, and referring to a step 24, the computing apparatus automatically calculates, in response to the determined risk, a fee for taking an action if the insurer does deny coverage for treating the insured—an embodiment of a computing apparatus configured to perform the steps 22 and 24, and the steps of other methods described hereinafter, is described below in conjunction with FIG. 16. For example, a computing apparatus may determine a risk that a primary insurer will deny coverage for a primary insured who undergoes (or seeks to undergo, e.g., at the recommendation of a physician) a relatively new chemotherapy regimen to treat the insured's cancer, and may calculate, in response to the determined risk, an insurance premium for another, e.g., coverage-denial insurer, to pay some or all of the cost of the chemotherapy regimen if the primary insurer does deny coverage.

Referring again to the step 22, the computing apparatus may determine the risk by mathematically determining, using statistics or other mathematical techniques, a probability that a primary insurer will deny coverage for treating an insured for a condition. For example, the computing apparatus may determine the probability that a primary insurer will deny coverage (e.g., direct payment or reimbursement) for reconstructive surgery that a primary insured receives, or seeks to receive, to correct facial deformities resulting from a car accident. Furthermore, the computing apparatus may determine the probability that the primary insurer will deny any and all coverage for treating the primary insured, or may determine the probability that the insurer will deny some, but not all, coverage. For example, the computing apparatus may compute multiple probabilities, such as a first probability that the primary insurer will deny any and all coverage, a second probability that the insurer will deny no more than a first percentage (e.g., 80%) or amount of coverage, a third probability that the insurer will deny no more than a second percentage (e.g., 50%) or amount of coverage, and so on; and the computing apparatus may take into account some or all of these multiple probabilities when calculating the fee for taking an action. Moreover, the computing apparatus may determine the probability that the primary insurer will not refuse all coverage, but will only delay paying some or all of the amount it owes for the treatment, and may also determine the probabilities of different delay periods; when calculating the fee for taking an action, the computing apparatus may take into account some or all of the possible delay periods and their associated probabilities. Therefore, as used herein, “denial of coverage” or the like encompasses delaying a payment or reimbursement for treating the primary insured beyond a specified, or unreasonable, time period, even where the primary insured does eventually provide payment or reimbursement for the treatment.

Furthermore, the computing apparatus may determine the risk before the primary insured is treated for the condition, at some point during a period of time over which the insured receives treatment for the condition, or after the insured has completed treatment for the condition but before the primary insurer indicates whether it will cover the treatment. And the computing apparatus may subsequently re-determine and refine the determined risk one or more times before the primary insurer indicates whether it will cover the treatment.

Moreover, although an embodiment of the method described in conjunction with FIG. 2 contemplates a human insured, the concepts described in this disclosure may also apply to a non-human insured such as a pet or a racehorse.

In addition, examples of treatments that the primary insured may receive, or seek to receive, for the condition include all types of surgery, surgical and other procedures, chemotherapy and other drug therapies, radiation therapy, hormone therapy, physical therapy, organ transplantation, blood transfusion, joint and other body-part replacement, dental procedure, psychological therapy or counseling, psychiatric therapy or counseling, sleep therapy, chiropractic therapy, physiological therapy such as massage therapy and physical therapy, shock therapy, homeopathic therapy, and acupuncture. Other examples of treatments that the primary insured may receive, or seek to receive, for the condition include all types of services such as a consultation with, or an examination or checkup by, a doctor, dentist, or other healthcare professional, lab work such as blood testing and urinalysis, vaccinations, and diagnostic imaging such as x-ray, MRI, CAT scan, PET scan, and ultrasound.

Furthermore, examples of conditions for which the primary insured may be treated, or may seek to be treated, include all types of medical conditions, physical conditions, mental conditions, addictions, injuries, illnesses, infections, and syndromes.

And referring again to the step 24 of FIG. 2, the computing apparatus may calculate the fee by mathematically calculating, using statistics or other mathematical techniques, the fee in response to the risk determined at the step 22. For example, the computing apparatus may calculate the fee at any time after the risk is determined at the step 22, and the computing apparatus may subsequently recalculate and refine the fee one or more times before the primary insurer renders its decision on whether it will accept or deny coverage for treating a primary insured.

Furthermore, the fee may include a coverage-denial insurance premium (which is separate and distinct from the premium paid under a primary insurance policy) or other monetary payment, or may include a non-monetary payment (e.g., a security) or a non-monetary obligation (e.g., an agreement to perform a service, or the performance of a service).

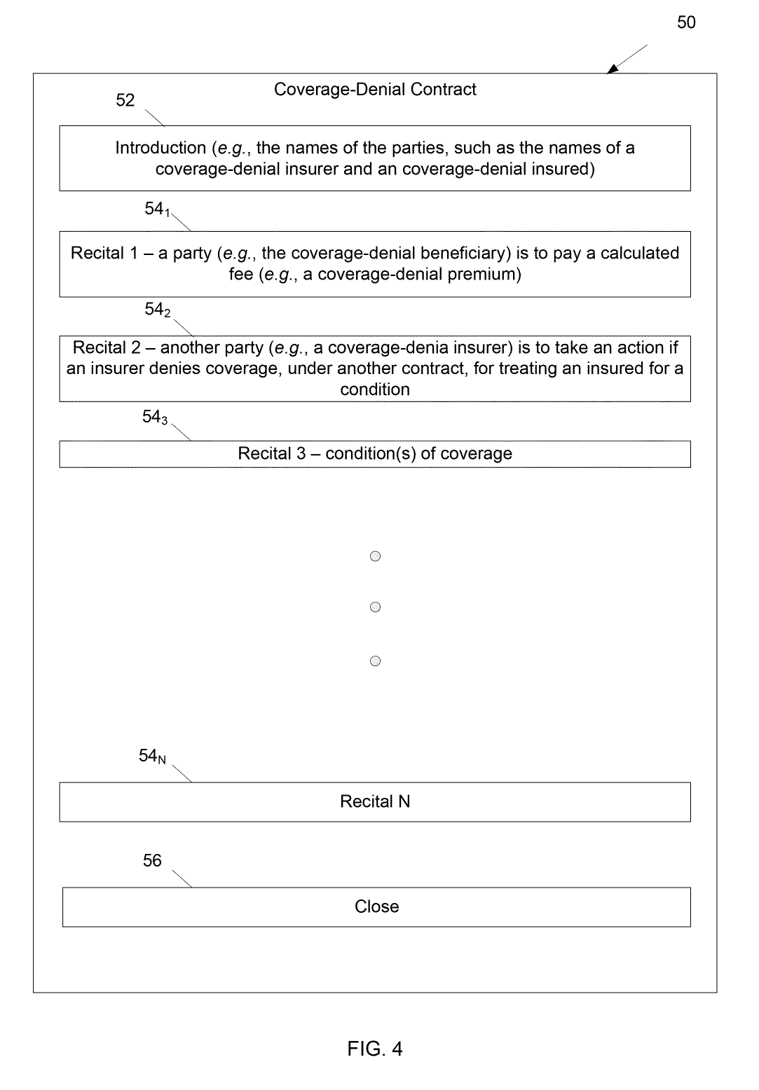

Moreover, examples of taking the action include paying money to a beneficiary of a coverage-denial contract (an embodiment of a coverage-denial contract is described below in conjunction with FIG. 4) such as a coverage-denial insurance policy, partially or fully reimbursing the beneficiary for the cost of treatment for which a primary insurer denied coverage, paying directly to a treatment provider the partial or full cost of treatment for which a primary insurer denied coverage, or surrendering an item or service of value to a beneficiary or to an appropriate public or private agency. Furthermore payment or reimbursement, whether partial or full, may be at a specified rate (e.g., per treatment item, or the rate at which the primary insurer would pay but for the coverage denial), a specified percentage of the treatment cost, a specified fixed amount, a specified fixed amount plus a specified percentage of the treatment cost, or capped at a specified amount. Moreover, such payment or reimbursement may not “kick in” unless and until the total cost of the coverage-denied treatment equals or exceeds a threshold cost. Other examples of taking the action include attempting to obtain partial or full payment or reimbursement for the cost of the treatment from the primary insurer via a settlement with the insurer, via the insurer's internal appeal procedure or a government appeal procedure, or by filing a lawsuit or taking other legal action against the insurer. Yet another example of taking the action includes providing to the primary insured the treatment for which the primary insurer denied coverage. And still another example of taking the action includes partially or fully reimbursing, e.g., the primary insured, a treatment provider, or a beneficiary under a coverage-denial contract, while the primary insurer is “stalling,” i.e., is delaying at least some payment for the treatment, beyond an unreasonable period or a period specified in, e.g., a coverage-denial contract (the paying/reimbursing party can then receive the amount later paid by the primary insurer as reimbursement).

In addition, taking the action may encompass taking more than one action either together or separately.

Still referring to FIG. 2, alternate embodiments of the method represented by the flow diagram 20 are contemplated. For example, the method may include steps in addition to the steps 22 and 24, may include only a single one of the steps 22 and 24, or one or both of the steps 22 and 24 may be modified. Furthermore, the computing apparatus may perform one or both of the steps 22 and 24 in a non-automatic manner, or in response to human or other intervention; alternatively, another type of apparatus, or even a human, may perform one or both of these steps.

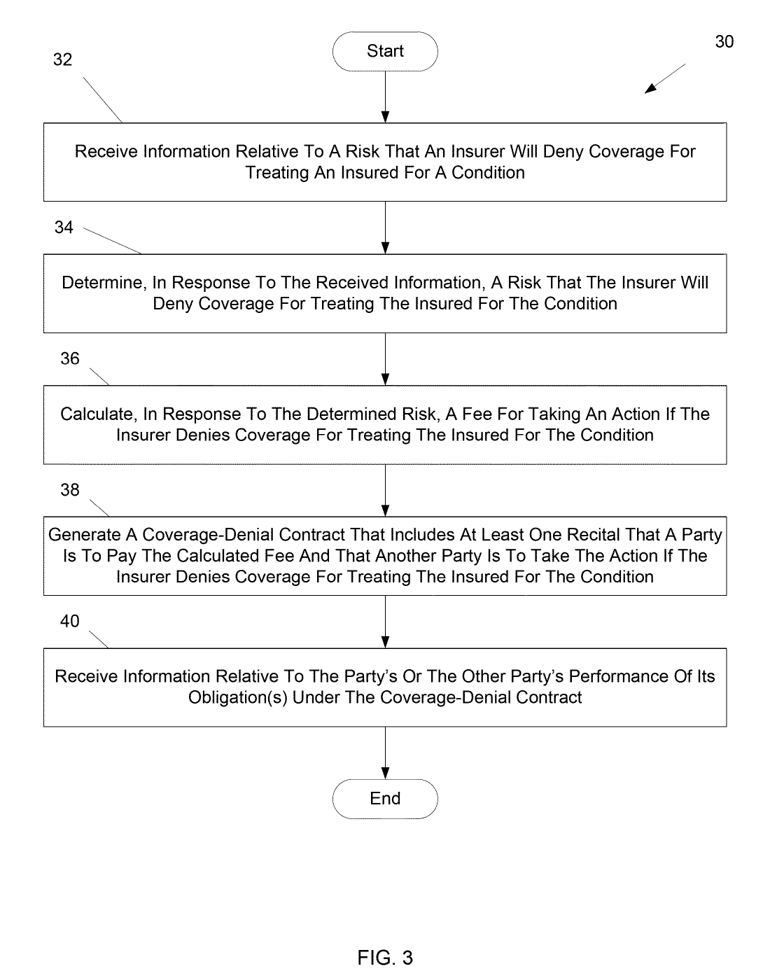

FIG. 3 is a flow diagram 30 of a method for managing a risk that a primary insurer will deny coverage, under a primary insurance policy or other contract, for treating a primary insured for a condition, according to an embodiment.

Referring to a step 32, a computing apparatus automatically receives information relative to a risk that a primary insurer will deny coverage for treating a primary insured for a condition.

Examples of such information include information about the primary insurer, the primary insured, the primary insurance policy that names the insured, the received or sought treatment, the treatment provider, and the condition.

Examples of information about the primary insurer include whether the insurer approved the treatment before the insured was (or is to be) treated, the insurer's overall claim-denial rate, the insurer's denial rate for the treatment and condition for which coverage is sought, whether the insurer has covered the treatment or condition for the insured or for another insured in the past, and the financial condition of the insurer. Other examples of information about the primary insurer include whether the insurer recommended or required one or more changes in the proposed treatment as part of a pre-approval of the treatment, the insurer's denial rate for follow-up care recommended or required after the treatment, and the likelihood that the insurer will cover such follow-up care even if the insurer denies coverage for the treatment. Yet another example of information about the primary insurer is the time (e.g., the average time) from when the insurer receives a claim to when the insurer pays the claim; this information can be relevant to whether the primary insurer “delays” or “stalls” payments or reimbursements for treatment of the primary insured. It is contemplated that it may be necessary to obtain at least some of this information from the primary insurer because the information is not contained within the primary insurance policy and is otherwise unavailable publically or from the primary insured.

Furthermore, examples of information about the primary insured include the current health, health history, and health profile of the insured, whether the insured has been treated previously for the condition or has otherwise previously received the treatment, and, if the insured has been treated previously for the condition, did the insured receive follow-up care after the treatment.

Moreover, examples of information about the primary insurance policy include the policy's terms and limitations of coverage such as whether the policy expressly covers or excludes the treatment or parts thereof, the policy's requirements such as whether the policy requires the primary insurer's pre-approval of the treatment, and the policy's payment/reimbursement terms such as whether the policy specifies a payment/reimbursement rate or algorithm, limits payment/reimbursement for the treatment (e.g., according to a preferred rate afforded to the primary insurer by treatment providers), or requires that payment be made within a certain time from receiving a valid claim.

In addition, examples of information about the treatment include the type, length, success rate, cost, and other characteristics of the treatment, whether follow-up care is recommended or required after the treatment is complete, other insurers' denial rates for the treatment, the individual steps/elements of the treatment, information about items (e.g., an artificial implant, or an organ for transplant) to be used as part of the treatment, and, if the primary insurer pre-approved the treatment and its pre-approval required or otherwise specified a change to the proposed treatment, whether the treatment provider agrees with/agreed to the change and whether the treatment administered/to be administered included/includes the change.

Furthermore, examples of information about the treatment provider (e.g., a physician or a hospital) include the number of times that the provider has administered the treatment, the success rate of the provider in treating the condition, whether the provider previously treated the insured for the condition, rates at which the primary insurer, and other insurers, have denied coverage of the provider's administering of one or more treatments, and the rates at which the primary insurer, and other insurers, have denied coverage of the provider's administering of the treatment for which coverage is sought.

And examples of information about the condition include the type, severity, cure rate, and other characteristics of the condition, how many courses of treatment are typically required to successfully treat the condition, and the cost associated with treating the condition.

Then, referring to a step 34, which can be similar to the step 22 of FIG. 2, the computing apparatus automatically determines, in response to the information received at the step 32, a risk that the primary insurer will deny coverage for treating the primary insured for the condition. For example, the computing apparatus may determine the risk by analyzing at least one item or step of the treatment (whether proposed or already administered) relative to at least one item or step covered by the primary insurance policy.

Next, referring to a step 36, which can be similar to the step 24 of FIG. 2, the computing apparatus automatically calculates, in response to the risk determined at the step 34, a fee for taking an action if the primary insurer does deny coverage for treating the primary insured for the condition. To calculate the fee, the computing apparatus may first determine, step-by-step, the action to be taken if the primary insurer denies coverage, and then calculate the fee in response to this determined step-by-step action. For example, the computing apparatus may determine the step-by-step treatment that the primary insured is seeking, and compare each step to a respective insurance code of the primary insurer to determine what steps the primary insurer should, or is likely, to cover, and the amount of coverage that the primary insurer specifies for each such step; the computer apparatus may also determine which treatment steps the primary insurance does not, or is otherwise unlikely, to cover. Furthermore, for any non-covered, or unlikely to be covered, step, the computing apparatus may identify an alternative step that the primary insurer should, or is likely, to cover, and base the fee on the treatment including such a step.

Then, referring to a step 38, the computing apparatus automatically generates a coverage-denial contract that includes at least one recital that a party is to pay the calculated fee, and that another party is to take the action if the primary insurer denies coverage for treating the primary insured for the condition under the primary insurance policy.

Still referring to the step 38, the computing apparatus may generate the coverage-denial contract in any suitable format, such as in electronic format or on paper via a printer that forms part of, or that is coupled to, the computing apparatus.

The coverage-denial contract can be any type of contract, such as a coverage-denial insurance policy, a risk-transfer financial instrument, a financial-swap agreement, or any other legally enforceable instrument, that includes at least one recital that a party is to pay the calculated fee and that another party is to take the action if the primary insurer denies coverage for treating the primary insured for the condition under the primary insurance policy. An embodiment of a coverage-denial contract is further described below in conjunction with FIG. 4.

The party that the coverage-denial contract obligates to pay the fee can be a single person, multiple persons, or any one or more non-person entities such as a business or trust. Examples of the fee-paying party include a beneficiary under the coverage-denial contract, such as a buyer of a right under the coverage-denial contract or a non-buyer beneficiary under the coverage-denial contract. Examples of such a beneficiary include the primary insured under the primary insurance policy, a parent, spouse, domestic partner, or other relative, legal guardian, employer, or other obligor of the primary insured, an employer or other obligor of a relative or legal guardian of the primary insured, a provider (e.g., a physician, hospital, medical clinic, or medical association) that treated, or that is proposing to treat, the primary insured for the condition, and a party that acquires the coverage-denial contract. The party that is obligated to pay the fee may also be referred to as a buyer or purchaser of the coverage-denial contract, or as a coverage-denial insured under the coverage-denial contract.

The other party that is obligated to take the action if the primary insurer denies coverage for treating the primary insured for the condition also can be a single person, multiple persons, or any one or more non-person entities, such as a business or trust. Examples of the obligated-to-take-the-action party include a coverage-denial insurer under the coverage-denial contract, the primary insured, and a treatment provider (e.g., a physician, hospital, medical clinic, or medical association) that treated, or that is proposing to treat, the primary insured for the condition. In the case of the primary insured being the party obligated to take the action, the primary insured may be confident enough in his/her ability to pay for the treatment in the event that the primary insurer denies coverage for the treatment, that he/she may sell the coverage-denial contract to, and thus act as a coverage-denial insurer of, the treatment provider. And, in the case of the treatment provider being the party obligated to take the action, the provider may be confident in its ability to forgo payment for administering the treatment if the primary insurer denies coverage for the treatment; therefore, the provider may sell the contract to, and thus act as a coverage-denial insurer of, the primary insured. The other party that is obligated to take the action may also be referred to as a seller or transferor of the coverage-denial contract, or as a coverage-denial insurer under the coverage-denial contract.

Still referring to the step 38, examples of paying the calculated fee, taking the action, treating the insured, and the condition are described above in conjunction with the step 24 of FIG. 2.

Next, referring to a step 40, the computing apparatus automatically receives information relative to the fee-paying party's performance of its obligation under the coverage-denial contract, information relative to the obligated-to-take-the-action party's performance of its obligation under the coverage-denial contract, or information relative to both parties' performances of their obligations under the coverage-denial contract. For example, the computing apparatus may receive such information in any suitable manner, such as from the internet via a local area network (LAN). Moreover, the computing apparatus may track the fee-paying party's payment of the fee calculated at the step 36, and may notify the obligated-to-take-the-action party if the fee-paying party is late with a payment. The computing apparatus also may receive information indicating that the primary insurer has denied coverage (e.g., including, but not limited to, delaying payment beyond an unreasonable or specified time) for treating the primary insured, and, in response to this information, may generate a notice to the obligated-to-take-the-action party that it needs to take the action specified in the coverage-denial contract. The computing apparatus may also track the obligated-to-take-the-action party, and may notify the fee-paying party or an enforcement agency (e.g., a government agency) if the obligated-to-take-the-action party does not timely take the action that it is obligated take under the coverage-denial contract.

Still referring to FIG. 3, alternate embodiments of the method represented by the flow diagram 30 are contemplated. For example, the method may include steps in addition to the steps 32-40, may omit one or more of the steps 32-40, or one or more of these steps may be modified. Furthermore, the computing apparatus may perform one or more of the steps 32-40 other than automatically, or in response to human or other intervention; or another type of apparatus, or even a human being, may perform one or more of these steps. Moreover, the computing apparatus may automatically generate more than one coverage-denial contract relating to the primary insurer denying coverage for treating the primary insured. In addition, if the risk determined at the step 36 is above a risk threshold or is too great for any reasonable fee, then the computing apparatus may recommend that no coverage-denial contract be generated.

FIG. 4 is a diagram of a coverage-denial contract 50, which a computing apparatus may automatically generate at the step 38 of FIG. 3, according to an embodiment.

The coverage-denial contract 50 includes an introduction 52, N recitals 54₁-54_{N}, where N≧1, and a closing 56, and may be fixed in any suitable non-transitory format such as paper or electronic.

The introduction 52 of the coverage-denial contract 50 may include, for example, the names and addresses of the parties to the contract, the names and addresses of any beneficiaries under the contract, the name and address of the primary insured under the primary insurance policy, information identifying the primary insurance policy or primary insurer, and a glossary or definitions of words or phrases that appear in the contract.

The recitals 54 each include a respective one or more terms of the coverage-denial contract 50; a recital can be in the form of a clause, paragraph, article, section, or other portion of the coverage-denial contract, and can be written expressly in the coverage-denial contract or can be incorporated into the coverage-denial contract by reference to another document (e.g., an appendix or another instrument) in which the recital is written or otherwise recorded.

Furthermore, the recitals 54 can specify the obligations of the parties to the coverage-denial contract 50, the conditions in response to which the obligations arise, the rights of any beneficiaries, and standard contract “boiler-plate” such as actions that constitute a breach of the contract, the venue for any dispute that may arise under the contract, the jurisdiction under whose laws the contract is to be interpreted, the effective start date of the contract, and the date (if any) on which the contract ends.

For example, Recital 1 54₁ of the coverage-denial contract 50 may recite, per the step 36 of the flow diagram 30 of FIG. 3, that a party to the contract is to pay a calculated fee, and Recital 2 44₂ may recite, per the step 38 of the flow diagram 30, that another party to the contract is to take an action if the primary insurer denies coverage for treating the primary insured for one or more specified conditions.

And Recital 3 54₃-Recital N 54_{N} of the coverage-denial contract 50 may recite other terms of the contract.

Examples of such other terms include the amount of the fee, the schedule for payment of the fee, the action that a party is required to take if the primary insurer denies coverage for treating the primary insured for a specified condition, conditions precedent to a party being required to take the action, a description of the specified condition and the treatment, the length and start date of the treatment period, and the obligations of non-parties. In an embodiment, a condition precedent is a condition, the fulfillment of which triggers an obligation of a party to act in a specified manner. That is, a condition precedent specifies an event that must occur before the party becomes obligated to act in the specified manner. Examples of conditions precedent are described below.

Regarding the action that a party is required to take if the primary insurer denies coverage for treating the primary insured for a specified condition, a recital of the coverage-denial contract 50 may specify, for example, that such action is a payout of an amount of money to, e.g., the primary insured or to a treatment provider (the payout can occur after the primary insured has already received the treatment, or before the primary insured has received the treatment such that the primary insured is able to afford the treatment despite the primary insurer's coverage denial). For example, the recital may specify a fixed amount of money, a fixed percentage of the treatment cost, an algorithmic payout (e.g., a fixed amount, plus a percentage of the retreatment costs above the fixed amount), a cap on the payout, that any payout is based only on costs that are actually denied by the primary insurer, and that a treatment provider or other beneficiary honor any preferred rate that the primary insurer would have been afforded had it decided to cover the treatment. It is also contemplated that a payout may exceed the cost of the treatment for which coverage is denied.

Further regarding the action that a party is required to take if the primary insurer denies coverage for treating the primary insured for a specified condition, a recital of the coverage-denial contract 50 may specify whether the coverage-denial contract covers follow-up care to the primary insured after the treatment if the primary insurer denies coverage for such follow-up care.

And regarding conditions precedent to a party being required to take the specified action, the coverage-denial contract 50 may specify which treatments, or portions of treatments, and which conditions, are covered under the coverage-denial contract. For example, the contract 50 may specify that if a primary insurer pre-approved a treatment, then the treatment must include all steps and items (e.g., supplies) recommended or required by the primary insurer's pre-approval; that is, there is no obligation under the coverage-denial contract to cover the treatment unless the primary insurer denies coverage (first triggering event) and the treatment is performed including all recommended or required steps (second triggering event). Furthermore, the contract 50 may specify that the treatment must include one or more specified steps (e.g., that a response of the primary insured to drug therapy be monitored weekly, and the drug dose adjusted as needed), alternative steps (e.g., physical therapy provided at an office may be provided at the primary insured's home), items (e.g., a particular type or brand of implant), or alternative items (e.g., a generic version of a drug may be substituted for a specified drug), that the treatment must exclude one or more steps or items (e.g., use of a specified implant not allowed), or that the treatment must be completed within a specified time frame or according to a specified schedule.

Further examples of such conditions precedent include that the primary insured must engage in one or more specified activities (e.g., make all treatment appointments, adhere to a specified diet) or refrain from specified activities (e.g., alcohol consumption, eating certain foods) during the treatment period or for a specified period of time after the treatment period, that the primary insured must exhaust all levels of the primary insurer's internal appeals process, that the primary insurer must issue a denial for coverage of the treatment in writing or, absent such written denial, delay payment for the treatment for at least a specified length of time, that the treatment provider confirm, in writing, that the steps of, items used in, and other characteristics of the treatment comply/will comply with any recommendations or requirements of the primary insurer (e.g., in a pre-approval) or with any recommendations or requirements of the coverage-denial contract, that the party obligated to take the action under the coverage-denial contract receive at least one invoice for the cost of the treatment as issued by the treatment provider, and that all premiums or other payments due under the primary insurance contact or the coverage-denial contract be kept current. And other examples of such conditions precedent include the primary insurer delaying payment for a specified period of time even if the primary insurer has affirmatively avowed coverage for the treatment.

Note that if any of the above-mentioned entities are not a party to the coverage-denial contract 50, then the one or more of the above-mentioned conditions precedent may be an obligation of a non-party.

Still other examples of such other terms of the coverage-denial contract 50 include limitations on a size of a portion of a party's obligations or rights under the coverage-denial contract that the party can transfer to a third party, limitations on the timing of such a transfer, and that a party be bonded or insured.

Yet another example of such other terms includes that the primary insured subrogates his/her rights under the primary insurance policy to the party obligated to take the action under the coverage-denial contract 50, and to the party's successors in interest, if the primary insurer denies coverage for treating the primary insured. Such subrogation of rights may provide the obligated party and its successors with legal standing to appeal the primary insurer's denial of coverage, to settle with, or to otherwise receive payment from, the primary insurer, or to otherwise take legal action against the primary insurer, on behalf of, or in place of, the primary insured.

Still referring to FIG. 4, the close 56 of the coverage-denial contract 50 may include the names, titles, and signatures of the parties, or of respective persons authorized to sign the contract on behalf of the parties.

Alternate embodiments of the coverage-denial contract 50 are contemplated. For example, the introduction 52, the close 56, or both the introduction and close, may be omitted from the contract 50, and any information that would otherwise be in the omitted one(s) of these sections instead may be included in one or more of the recitals 54. Furthermore, as described above in conjunction with FIG. 3, the coverage-denial contract 50 may be, or may include, a coverage-denial insurance policy or any other type of risk-transfer contract or risk-transfer financial instrument. Moreover, although the coverage-denial contract 50 is described as specifying one treatment for one condition of a primary insured, the contract may specify more than one treatment for, or more than one condition of, the primary insured.

Referring to FIGS. 2-4, a computing apparatus automatically generating multiple coverage-denial contracts 50 is also contemplated. For example, to hedge its risk, a seller of one coverage-denial contract 50 may be a buyer of another coverage-denial contract 50, where both contracts cover the same primary insurer denying coverage for treating the same primary insured for the same one or more conditions.

Furthermore, after the coverage-denial contract 50 is generated and entered into by at least a fee-paying party (e.g., a buyer) and an obligated-to-take-an-action party (e.g., a seller) as described above in conjunction with FIGS. 3-4, it is contemplated that any of the parties, and any of the beneficiaries, may transfer their respective rights and obligations under the contract to respective third parties. For example, the seller may transfer its right to collect the fee from the buyer, or its obligation to take the action if the primary insurer denies coverage, to a third party. Or, the seller may transfer its right to collect the fee from the buyer to a creditor as payment of debt that the seller owes the creditor. In addition, the seller may sell its right to collect the fee and its obligation to take the action; although the seller typically will make a reduced amount of money as compared to collecting the fee, it has shed the obligation to take the action. Likewise, the buyer, or a non-buyer beneficiary, entitled to receive the benefit of the taken action may transfer its right to receive this benefit to a third party.

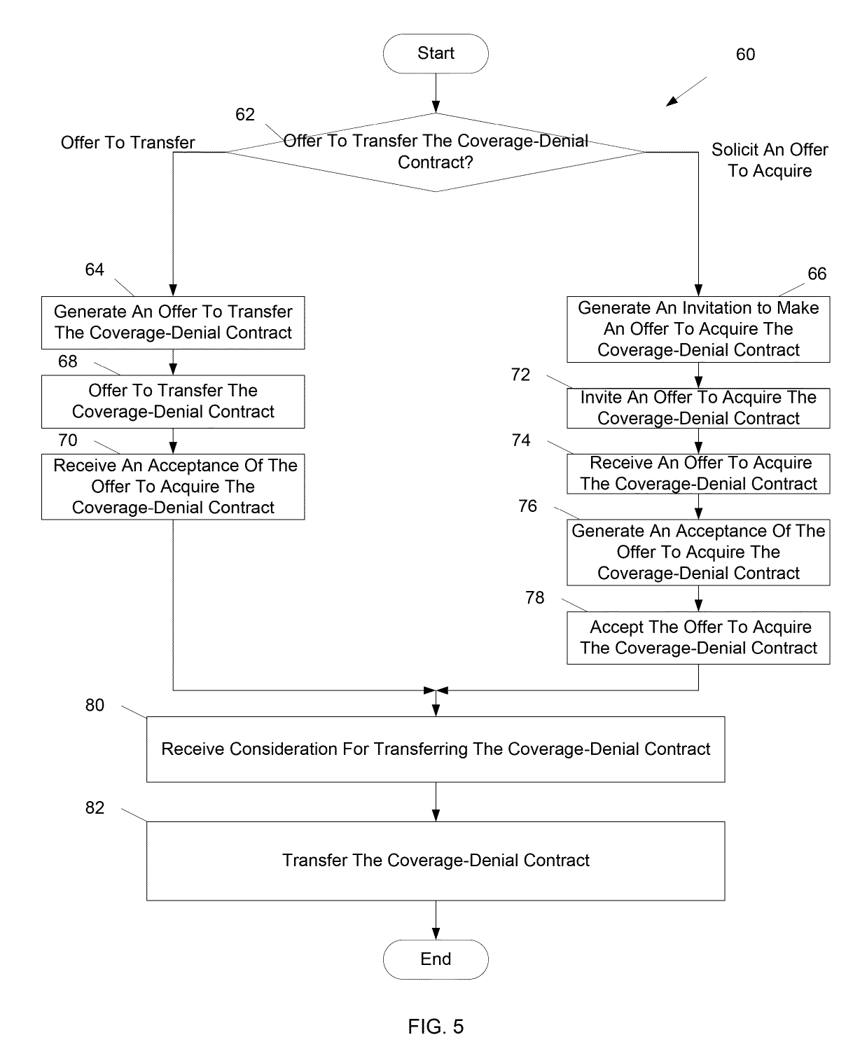

FIG. 5 is a flow diagram 60 of a method for transferring at least one right or obligation under a coverage-denial contract, such as the coverage-denial contract 50 of FIG. 4, according to an embodiment. Hereinafter, terms such as “transferring the coverage-denial contract” and “selling the coverage-denial contract” refer to the transfer/sale of one or more rights or obligations under the contract to one or more third parties, where the transfer may, or may not, be for money or other consideration in return. For example, referring to FIGS. 2 and 3, the beneficiary of the action to be taken by a party in the event that the primary insurer denies coverage for treating the primary insured for a condition may “transfer the coverage-denial contract” to a third party by transferring to the third party the right to receive the action taken if the action is taken. Or, a party entitled to receive the fee paid by another party under the coverage-denial contract may “sell the coverage-denial contract” to a third party by selling to the third party the right to receive the fee. Furthermore, although the flow diagram 60 describes an embodiment of the method in conjunction with the coverage-denial contract 50 of FIG. 4, it is understood that an embodiment of the method is suitable for coverage-denial contracts other than the coverage-denial contract 50, and for other contracts and instruments in general.

Referring to a step 62, a computing apparatus first determines automatically whether to offer the coverage-denial contract 50 (FIG. 4) for transfer or to solicit an offer to acquire the contract. The computing apparatus may make this determination based on information it receives regarding the transfer of the contract 50. For example, the computing apparatus may receive information indicating that a party to the contract 50 would like to sell its rights in the contract to a third party for a specified price.

If the computing apparatus “decides” to offer the coverage-denial contract 50 for transfer, then the computing apparatus proceeds to a step 64; otherwise, the computing apparatus proceeds to a step 66.

Referring to the step 64, the computing apparatus automatically generates an offer to transfer the coverage-denial contract 50 (FIG. 4), where the generated offer may be in any suitable format such as paper or electronic format. For example, the computing apparatus may generate an offer to transfer to a third party the right to receive the fee (e.g., a coverage-denial insurance premium paid on a monthly basis) that a party is obligated to pay under the contract 50.

Next, referring to a step 68, the computing apparatus automatically makes an offer to transfer the coverage-denial contract 50 (FIG. 4). For example, the computing apparatus may cause the offer generated at the step 64 to be published in an online market place such as Craig's List® or E-Bay®, or may send the offer directly to potential transferees.

Then, referring to a step 70, the computing apparatus receives an acceptance of the offer to transfer the contract 50 (FIG. 4). For example, the computing apparatus may receive the acceptance from the accepting party in an email, text, voice communication, or other electronic communication received via the internet or a phone system.

But if, at the step 62, the computing apparatus instead “decides” to solicit an offer to acquire the contract 50 (FIG. 4) instead of offering to transfer the contract, then, referring to the step 66, the computing apparatus automatically generates an invitation to make an offer to acquire the coverage-denial contract, where the generated invitation may be in any suitable format such as electronic or paper format. For example, the computing apparatus may generate an invitation to make an offer or bid to acquire the right under the contract 50 to receive the fee (e.g., a coverage-denial insurance premium paid on a monthly basis) due under the contract.

Next, referring to a step 72, the computing apparatus automatically solicits an offer to acquire the coverage-denial contract 50 (FIG. 4). For example, the computing apparatus may cause the invitation generated at the step 66 to be published in an online market place such as Craig's List® or E-Bay®, or may send the invitation directly to potential acquirers.

Then, referring to a step 74, the computing apparatus automatically receives an offer to acquire the contract 50 (FIG. 4). For example, the computing apparatus may receive the offer from the offering third party in an email, text, voice mail, or other electronic communication via the internet or a phone system.

Next, referring to a step 76, the computing apparatus automatically generates an acceptance of the received offer to acquire the coverage-denial contract 50 (FIG. 4), where the generated acceptance may be in any suitable format such as electronic or paper format.

Then, referring to a step 78, the computing apparatus automatically accepts the offer to acquire the coverage-denial contract 50 (FIG. 4). For example, the computing apparatus may send the acceptance generated at the step 76 via email to the third party who made the offer.

Next, after whichever of the step 70 and the step 78 that the computing apparatus performs, referring to a step 80, the computing apparatus automatically receives consideration from the acquirer for transferring the coverage-denial contract 50 (FIG. 4) to the acquirer. For example, the computing apparatus may receive an electronic payment from the credit card, debit card, or bank account of the acquirer. And if the acquirer is obligated to make one or more future payments (e.g., monthly coverage-denial insurance premiums), then the computing apparatus may also automatically receive or track these payments in due course.

Then, referring to a step 82, the computing apparatus automatically transfers the coverage-denial contract 50 (FIG. 4) to the acquirer. For example, the computing apparatus may generate and send to the acquirer a copy of the contract 50 and a purchase agreement that memorializes the details of the transfer.

Still referring to FIG. 5, alternate embodiments of the method represented by the flow diagram 60 are contemplated. For example, the method may include steps in addition to the steps 62-82, may omit one or more of the steps 62-82, or may modify one or more of these steps. Furthermore, the computing apparatus may perform one or more of the steps 62-82 other than automatically, or in response to human or other intervention; or another type of apparatus, or even a human, may perform one or more of these steps.

Referring to FIGS. 2-5, instead of managing its risk of incurring coverage-denial liability on a primary-insured-by-primary-insured basis (e.g., with a separate coverage-denial contract for each treated primary insured), a party such as a treatment provider (e.g., a physician, hospital, or clinic) may want to manage its risk of incurring liability due to coverage denials over a period of time regardless of how many primary insured are treated, or regardless of the conditions for which the primary insured are treated, during this period.

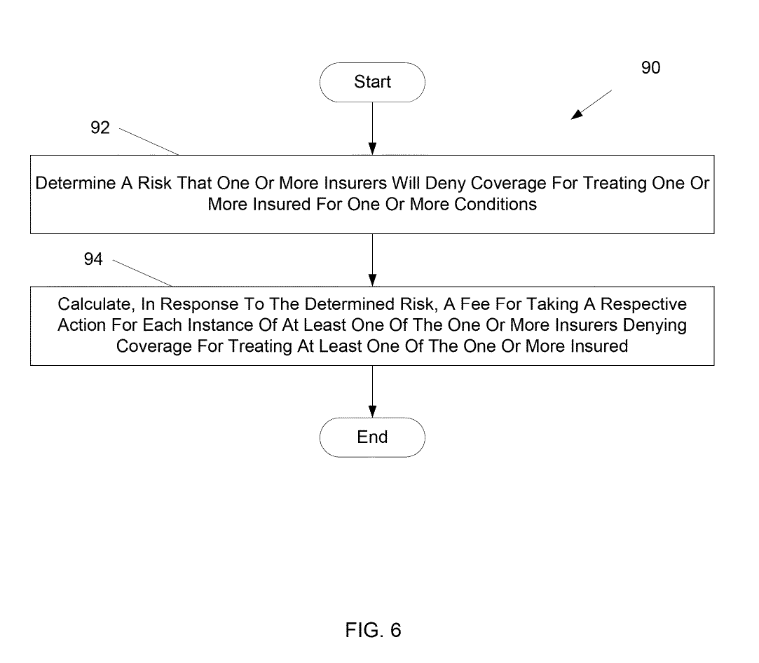

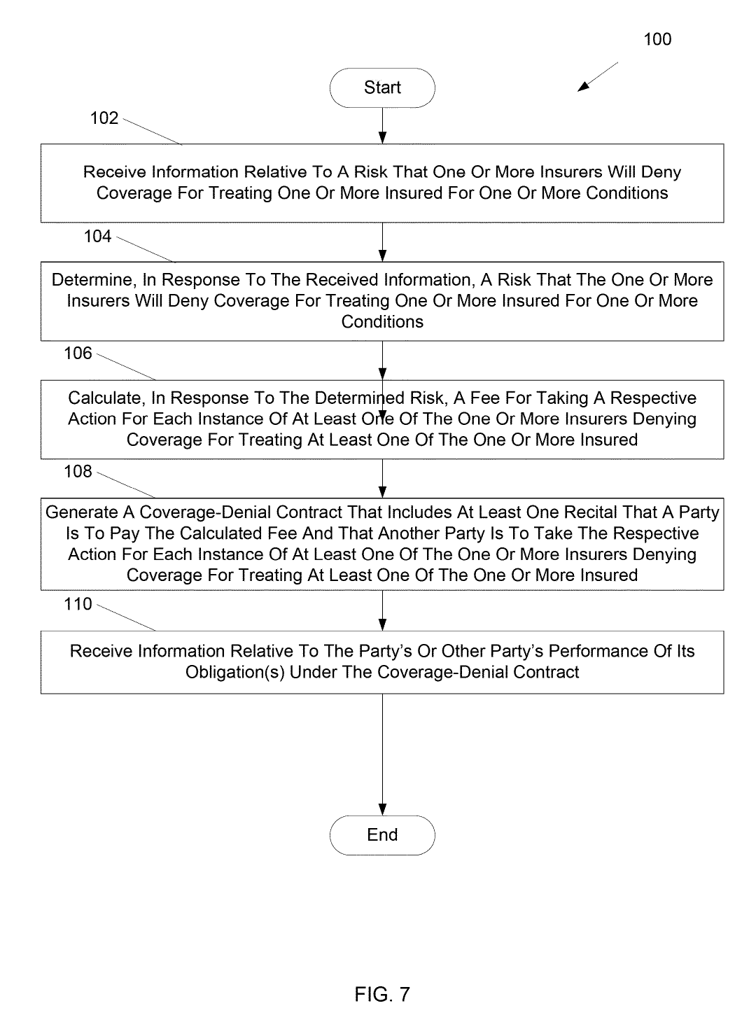

Consequently, described below in conjunction with FIGS. 6-7 are embodiments of methods that one can use to assist a party (e.g., a treatment provider) in managing its risk of incurring coverage-denial liability if one or more primary insurers deny coverage for treating one or more primary insured for one or more conditions during a coverage period. Furthermore, embodiments of the below-described methods may be utilized by any parties to the contract, or third parties, other than treatment providers.

FIG. 6 is a flow diagram 90 of a method for managing a risk that one or more primary insurers will deny coverage for treating one or more primary insured for one or more conditions, according to an embodiment.

Referring to a step 92, a computing apparatus automatically determines a risk that one or more primary insurers will deny coverage for treating one or more primary insured for one or more conditions, and referring to a step 94, the computing apparatus automatically calculates, in response to the determined risk, a fee for taking a respective action for each instance of at least one of the one or more primary insurers denying coverage for treating at least one of the one or more primary insured.

Referring again to the step 92, the computing apparatus may determine the risk by mathematically determining, using statistics or other mathematical techniques, a probability that at least one of the one or more primary insurers will deny coverage for treating at least one of the one or more primary insured, and how many instances of such coverage denial are likely to occur.

Furthermore, the computing apparatus may determine the risk for a coverage time period, which may be separate and distinct from the one or more coverage periods during which the one or more primary insured are covered by one or more primary insurance policies. In general, the coverage time period is a period (e.g., one year) during which each of the one or more primary insured receives a least a portion of a respective treatment for a respective condition, i.e., which overlaps with at least a portion of the respective treatment time period for each of the one or more primary insured. For example, for a hospital, the coverage period may be a span during which each of the one or more primary insured receives at least one portion of treatment for at least one condition; that is, all of the primary insured who receive treatment at the hospital during the coverage period form the “one or more primary insured” for which the computing apparatus calculates the risk. Alternative examples include the coverage period being a span during which each of the one or more primary insured is at least admitted for treatment, a span during which each of the one or more primary insured is discharged from treatment, a span during which the respective treatment period for each of the one or more primary insured begins or ends, a span during which one or more primary insurers denies coverage for at least one of the one or more primary insured, or a span during which multiple ones of these factors occur. As an example of a span during which one or more primary insurers denies coverage for at least one of the one or more primary insured, if the coverage period runs from Jan. 1, 2013 to Dec. 31, 2013 and a primary insurer denies coverage on Dec. 15, 2013 for treating a primary insured, then the primary insured falls within the coverage period because a primary insurer denied coverage for the primary insured's treatment prior to January 2014; in contrast, if the primary insurer denies coverage on Jan. 15, 2014 for treating a primary insured, then the primary insured does not fall within the coverage period, even if the hospital treated the primary insured during 2013—of course this coverage denial may fall within a subsequent coverage time period.

Moreover, the computing apparatus may determine the risk before, during, or even after the coverage time period.

In addition, the computing apparatus may determine the risk before at least one of the one or more primary insured is even treated for a respective condition, at some point during a period of time over which at least one of the one or more primary insured is being treated for the respective condition, or after at least one of the one or more primary insured has completed treatment for the respective condition.

And the computing apparatus may subsequently re-determine and refine the risk one or more times before the expiration of the coverage time period.

Furthermore, the one or more primary insured may be patients of a single treatment provider, or of multiple treatment providers, or at least one of the one or more primary insured may have a non-patient relationship to the respective treatment provider. An example of the former includes a company that owns multiple hospitals, and the risk is determined for primary insured receiving treatment at any of these hospitals. And an example of the latter is where the at least one of the one or more primary insured is a participant in a clinical trial. And although an embodiment of the method described in conjunction with FIG. 6 contemplates human insured, the concepts described in this disclosure may also apply to non-human insured, such as pets or racehorses.

Moreover, examples of treatments that the one or more insured may receive, and conditions for which the one or more insured may receive such treatments, are described above in conjunction with FIG. 2.

In addition, determining a risk that one or more primary insurers will deny coverage for treating one or more primary insured can include determining a risk that one or more primary insurers will deny a number of claims over and above a threshold number of claims. For example, the computing apparatus may determine the risk that more than a percentage (e.g., 1%, 2%, or 3%) of all insurance claims submitted on behalf of the one or more primary insured will be denied. Determining the risk in this manner may be useful, for example, where a party such as a treatment facility wants to manage the risk of the number of insurance-coverage denials exceeding a particular absolute number or a particular percentage of all claims submitted.

Still referring to FIG. 6, and referring again to the step 94, the computing apparatus may calculate the fee by mathematically calculating, using statistics or other mathematical techniques, the fee in response to the risk determined at the step 92. For example, the computing apparatus may calculate the fee at any time after the risk is determined at the step 92, and the computing apparatus may subsequently recalculate or otherwise refine the fee one or more times before the expiration of the coverage period.

Examples of the fee and of its possible structure are described above in conjunction with FIGS. 2 and 4.

Furthermore, examples of taking the respective action include paying money to a beneficiary of a coverage-denial contract, such as a coverage-denial insurance policy, and partially or fully reimbursing or paying the beneficiary for the cost of treating at least one of the one or more primary insured for which at least one of the one or more primary insurers have denied treatment coverage (as described above in conjunction with FIGS. 2-3, the primary insured may be treated for the condition before or after the primary insurer denies coverage for the treatment, and denial of coverage may include the primary insurer “stalling” payment/reimbursement for at least a specified delay time even though it is anticipated that the primary insurer will eventually pay/reimburse for the treatment). Furthermore, taking the respective action may encompass taking multiple respective actions either together or separately for each instance of a primary insurer denying coverage for treating a primary insured for a condition. Additional examples of taking the action are described above in conjunction with FIGS. 2-5, where these examples can be modified for implementation where there are one or more primary insurers or one or more primary insured.

Still referring to FIG. 6, alternate embodiments of the method represented by the flow diagram 90 are contemplated. For example, the method may include steps in addition to the steps 92 and 94, may include only a single one of the steps 92 and 94, and one or both of the steps 92 and 94 may be modified. Furthermore, the computing apparatus may perform one or both of the steps 92 and 94 in a non-automatic manner, or in response to human or other intervention; alternatively another type of apparatus, or even a human, may perform one or both of these steps.

FIG. 7 is a flow diagram 100 of a method for managing a risk that one or more primary insurers will deny coverage for treating one or more primary insured for one or more conditions, according to another embodiment.

Referring to a step 102, a computing apparatus automatically receives information relative to a risk that one or more primary insurers will deny coverage for treating one or more primary insured for one or more conditions. Examples of such information are described above in conjunction with FIG. 3. Additional examples of such information include the number (if known at the time that a coverage-denial contract is generated) of the one or more primary insurers or primary insured to be covered, the threshold number (if any) of claim denials above which the risk is to be determined, the length and timing of the coverage-denial contract's coverage period, and which primary insured are covered by which primary insurers (e.g., it is contemplated that a primary insured may have primary insurance policies with more than one of the primary insurers).

Then, referring to a step 104, which can be similar to the step 92 of FIG. 6, the computing apparatus automatically determines, in response to the information received at the step 102, the risk that the one or more primary insurers will deny coverage for treating one or more primary insured for one or more conditions during a coverage period; the computing apparatus may also automatically estimate the number of such coverage denials that will occur during the coverage period.

Next, referring to a step 106, which can be similar to the step 94 of FIG. 6, the computing apparatus automatically calculates, in response to the risk determined at the step 104, a fee for taking a respective action for each instance of one of the one or more primary insurers denying coverage for treating one of the one or more primary insured.

Then, referring to a step 108, the computing apparatus automatically generates a coverage-denial contract that includes at least one recital that a party is to pay the calculated fee, and that another party is to take the respective action for each instance of one of the one or more primary insurers denying coverage for treating one of the one or more primary insured. For example, the computing apparatus may generate a coverage-denial contract that is similar to the coverage-denial contract 50 of FIG. 4, but with the recitals modified to reflect that the contract covers the denial of coverage by one or more primary insurers for treating one or more primary insured. Furthermore, the computing apparatus may generate the coverage-denial contract in any suitable format, such as in electronic format or on paper via a printer coupled to, or part of, the computing apparatus.

Still referring to the step 108, the party that is obligated to pay the fee calculated at the step 106 can be a single person, multiple persons, or any one or more non-person entities such as a business or trust. Examples of the fee-paying party include a beneficiary under the coverage-denial contract such as a buyer of a right under the coverage-denial contract, a coverage-denial insured under the coverage-denial contract, and a treatment provider (e.g., a physician, hospital, medical clinic, or medical association) associated with treating at least one of the one or more primary insured for the one or more conditions. Other examples of the party paying the fee are described above in conjunction with FIGS. 2-4.

The party that is obligated to take the respective action described above in conjunction with the steps 106 and 108 also can be a single person, multiple persons, or any one or more non-person entities such as a business or trust. Examples of the action-obligated party include a coverage-denial insurer (e.g., of a treatment provider) under the coverage-denial contract, a seller of a right under the coverage-denial contract (e.g., to the fee-paying party), at least one of the one or more primary insured (e.g., the at least one primary insured may act as a coverage-denial insurer to the fee-paying party), and at least one treatment provider (e.g., a physician, hospital, medical clinic, or medical association) associated with treating at least one of the one or more primary insured. Other examples of the party obligated to take the respective action are described above in conjunction with FIGS. 2-4.

Still referring to the step 108, examples of taking the respective action, a respective retreatment of a respective one of the one or more primary insured, and a respective one of the one or more conditions, are described above in conjunction with the step 24 of FIG. 2 and the step 36 of FIG. 3.

Furthermore, after the computing apparatus generates the coverage-denial contract at the step 108, the computing apparatus may transfer the contract to a third party in a manner similar to that described above in conjunction with FIG. 5.

Next, referring to a step 110, the computing apparatus automatically receives information relative to the fee-paying party's or the action-obligated party's performance of its obligation under the coverage-denial contract. For example, the computing apparatus may receive such information in any suitable manner, such as from the internet via a local area network (LAN). Moreover, the computing apparatus may track the fee-paying party's payment of the fee calculated at the step 106, and may notify the action-obligated party (or other party) if the fee-paying party is late with a payment. The computing apparatus also may receive information indicating that at least one of the one or more primary insurers has denied coverage for treating at least one of the one or more primary insured, and, in response to this information, may generate a notice to the action-obligated party that it needs to take the respective action specified in the coverage-denial contract. Furthermore, the computing apparatus may also track the action-obligated party, and may notify the fee-paying party or another party (e.g., a government agency such as a state insurance commission) if the action-obligated party does not take the respective action when it is obligated to do so under the contract.

Still referring to FIG. 7, alternate embodiments of the method represented by the flow diagram 100 are contemplated. For example, the method may include steps in addition to the steps 102-110, may omit one or more of the steps 102-110, or one or more of these steps may be modified. Furthermore, the computing apparatus may perform one or more of the steps 102-110 other than automatically, or in response to human or other intervention; or another type of apparatus, or even a human being, may perform one or more of these steps. In addition, if the risk determined at the step 104 is above a risk threshold or is too great for any reasonable fee, then the computing apparatus may recommend that no coverage-denial contract be generated.

Referring again to FIG. 5, even though a computing apparatus can transfer a coverage-denial contract, such as the coverage-denial contract 50 of FIG. 4 or the coverage-denial contracts described above in conjunction with FIGS. 6-7, many potential acquirers, such as an investor, may believe it is too risky to acquire a single coverage-denial contract. For example, suppose that an investor wants to acquire the right to receive the payment(s) of the fee under a coverage-denial contract as an investment, but also must acquire the obligation to take an action (e.g., pay for treatment) if a primary insurer denies coverage for treating a primary insured. Because the cost of taking the action may far exceed the amount of the fee, the investor may be taking a relatively large risk that it will lose money on the investment if even one primary insured is denied coverage for treatment of a condition.

Consequently, to reduce its overall risk exposure, an investor may wish to acquire multiple coverage-denial contracts, the theory being that the payments from all of the contracts may exceed the costs for taking a respective action for one or more primary insured whose coverage is denied by a primary insurer under a primary insurance policy.

But acquiring multiple coverage-denial contracts one by one may be tedious and otherwise uneconomical.

Furthermore, depending on the number and terms of the coverage-denial contracts acquired, the acquirer's overall risk exposure may not be that much smaller, and may even be the same or greater, than the overall risk exposure of a single coverage-denial contract.

Consequently, to reduce its overall risk, an investor may wish to balance its investment portfolio by acquiring a number of different types of instruments, including one or more coverage-denial contracts, that may each have a relatively high, or otherwise relatively unattractive, risk, but that together can have an aggregate risk that is relatively low, or otherwise relatively attractive.

Because many investors are not sophisticated enough to determine which, and how many, coverage-denial contracts and other instruments will provide a desired aggregate risk profile, an entity such as an investment company may package a number of such instruments together to form an asset having a defined risk profile and having shares that the entity can sell, or otherwise transfer, to one or more investors.

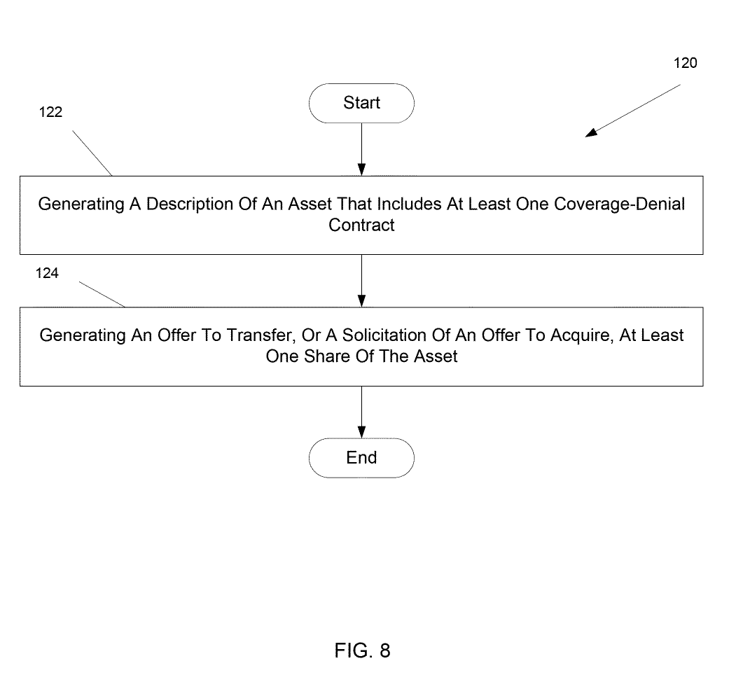

An asset that includes at least one coverage-denial contract, such as the coverage-denial contract 50 (FIG. 4) or the coverage-denial contracts described in conjunction with FIGS. 6-7, and methods related to the formation and transfer of such an asset, are described below in conjunction with FIGS. 8-11, according to an embodiment.

FIG. 8 is a flow diagram 120 of a method for generating a description of, and an offer to transfer, or a solicitation of an offer to acquire, at least one share of an asset that includes at least one coverage-denial contract, according to an embodiment. For example, the asset may include at least one coverage-denial contract 50 of FIG. 4, or at least one of the coverage-denial contracts described above in conjunction with FIGS. 6-7.

Referring to a step 122, a computing apparatus automatically generates a description of an asset that includes at least one coverage-denial contract and at least one other instrument. The description may include the type(s) of coverage-denial contract(s) and other instruments included in the asset, and may include the rights and obligations of the parties to each contract and each instrument that are included in the asset. For example, the description may specify that the asset will receive payments of all fees under a coverage-denial contract, but will be obligated to pay a specified fraction, or a full amount, of the costs of any treatments of one or more primary insured for which one or more primary insurers deny coverage within a respective coverage period. Furthermore, the description may include the number and classes of shares of the asset. Moreover, the computing apparatus may generate the description of the asset before or after the asset is formed. In addition, the computing apparatus may generate the description of the asset in any suitable format, such as on paper or in an electronic file.

Next, referring to a step 124, the computing apparatus automatically generates an offer to transfer, or a solicitation of an offer to acquire, at least one share of the asset that is the subject of the description generated at the step 122 above; for example, a solicitation of an offer may be made in a situation where the asset seller wants potential transferees to bid on shares of the asset. The offer or solicitation of an offer may include the generated description of the asset, and the share price for each share class of the asset. Furthermore, the computing apparatus may generate the offer to transfer, or the solicitation of an offer to acquire, at least one share of the asset before or after the asset is formed. Moreover, the computing apparatus may generate the offer to transfer, or the solicitation of an offer to acquire, at least one share of the asset in any suitable format, such as on paper or in an electronic file.

Still referring to FIG. 8, alternate embodiments of the method represented by the flow diagram 120 are contemplated. For example, the method may include steps in addition to the steps 122-124, may omit one of the steps 122-124, and one or more of these steps may be modified. Furthermore, the computing apparatus may perform one or more of the steps 122-124 other than automatically, or in response to human or other intervention; or another type of apparatus, or even a human being, may perform one or more of these steps. Moreover, the computing apparatus may automatically repeat the step 124 as appropriate to make multiple offers or multiple solicitations of offers.

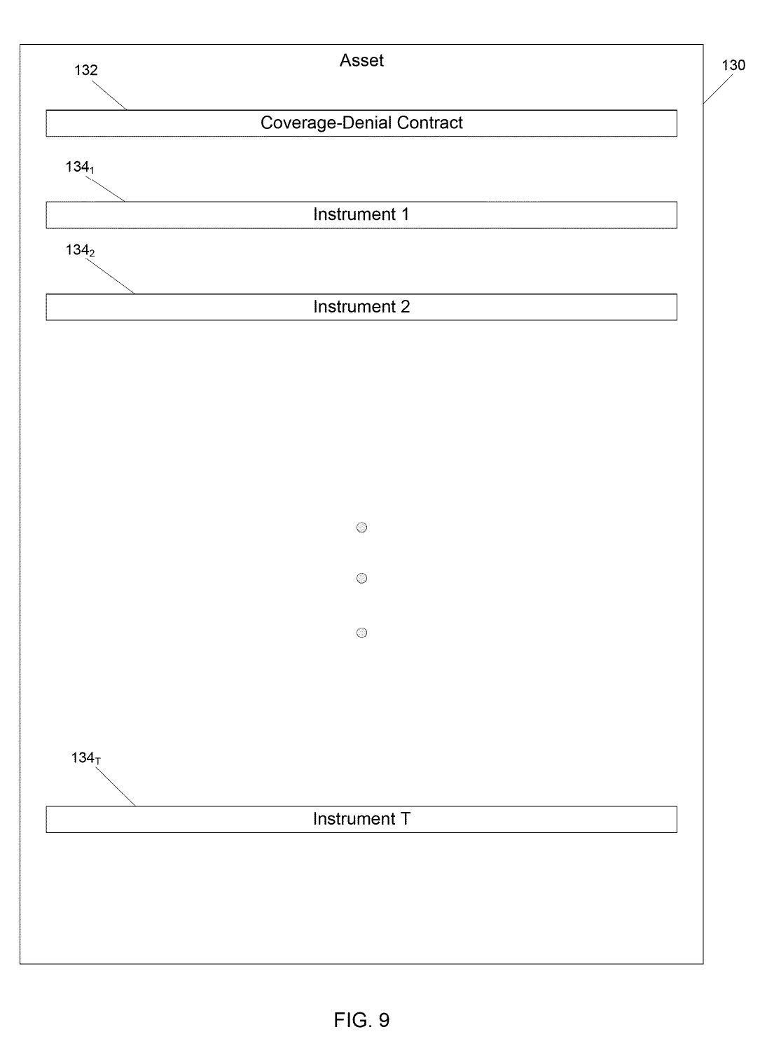

FIG. 9 is a diagram of an asset 130 that includes at least one coverage-denial contract 132, according to an embodiment. For example, the coverage-denial contract 132 may be similar to the coverage-denial contract 50 of FIG. 4, or similar to one of the coverage-denial contracts described above in conjunction with FIGS. 6-7. And in addition to the at least one coverage-denial contract 132, the asset 130 may include at least one other instrument 134₁-134_{T}, where T≧1.

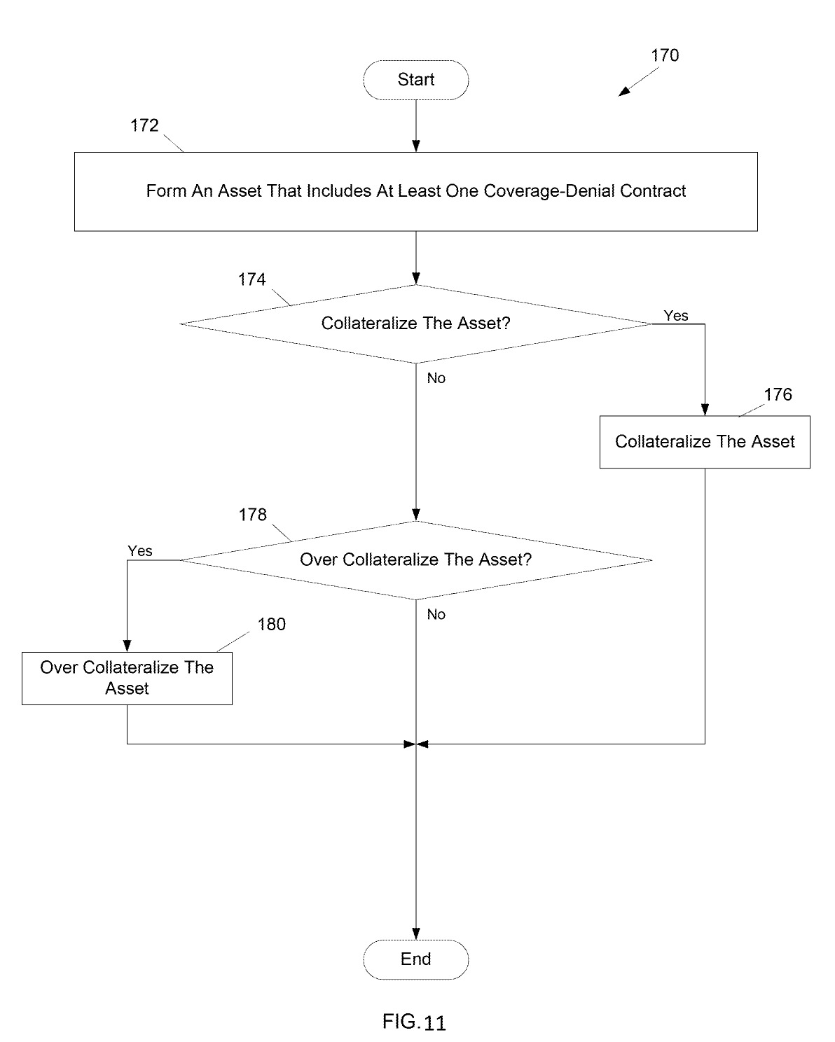

Examples of the asset 130 include a pooled asset, bundled asset, collateralized asset, and over-collateralized asset, which are further described below in conjunction with FIG. 11, and any other asset that can include at least one coverage-denial contract.

And examples of the at least one instrument 134 include a financial instrument, negotiable instrument, another contract such as an insurance policy (e.g., a primary medical insurance policy or a coverage-denial medical insurance policy), another coverage-denial contract, and any other type of instrument that can be combined with at least one coverage-denial contract to form the asset 130. If the at least one instrument 134 includes one or more coverage-denial contracts other than the coverage-denial contract 132, then these one or more other coverage-denial contracts may include one or more terms that are different than the respective terms of the coverage-denial contract 132. For example, the one or more other coverage-denial contracts may identify different primary insurers, different primary insured, different parties, different beneficiaries, different conditions, different fees, different coverage periods, different actions to be taken, or different limitations on transferring rights or obligations under the contract relative to the coverage-denial contract 132.

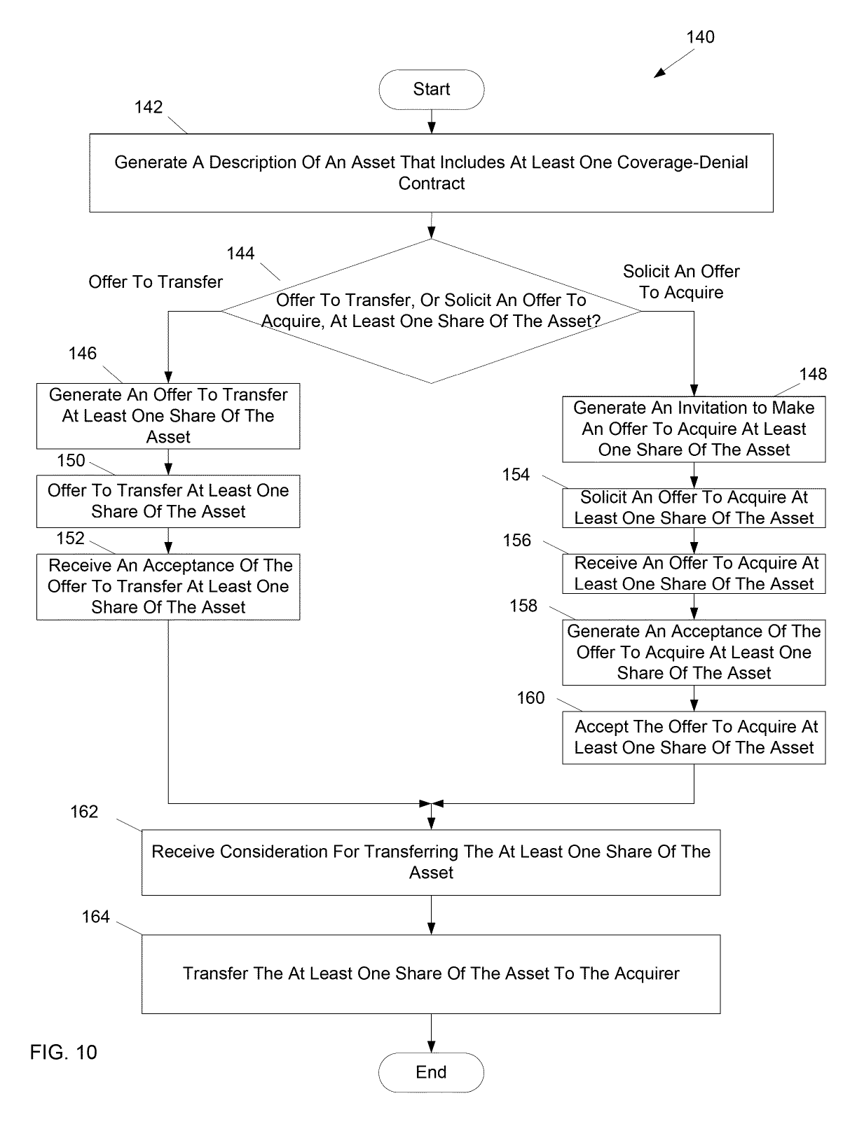

FIG. 10 is a flow diagram 140 of a method for generating a description of, and for managing a transfer of, an asset that includes at least one coverage-denial contract, according to an embodiment. For example, the asset may be, or may be similar to, the asset 130 of FIG. 9. Hereinafter, terms such as “transferring the asset,” “selling the asset,” “transferring shares in the asset,” and “selling shares in the asset” refer to the transfer/sale to one or more third parties one or more shares of one or more rights or obligations under the items (e.g., at least one coverage-denial contract) that form the asset, where the transfer may, or may not, be for return consideration. For example, shares of the asset 130, which include shares of the right to receive the fee under the coverage-denial contract, may be sold to one or more investors.

Referring to a step 142, a computing apparatus automatically generates a description of an asset that includes at least one coverage-denial contract, such as the coverage-denial contract 132 of FIG. 9, according to an embodiment; the asset may also include at least one other instrument, such as another instrument 134 of FIG. 9. Details of this step may be similar to those described above in conjunction with the step 122 of FIG. 8.

Next, referring to a step 144, the computing apparatus automatically determines whether to offer at least one share of the asset for transfer or to solicit an offer to acquire at least one share of the asset.

If, at the step 144, the computing apparatus “decides” to offer at least one share of the asset 130 for transfer, then the computing apparatus proceeds to a step 146; otherwise, the computing apparatus proceeds to a step 148.

Referring to the step 146, the computing apparatus automatically generates an offer to transfer at least one share of the asset, where the generated offer may be in any suitable format such as paper or electronic format. For example, the computing apparatus may generate an offer to transfer to a third party one or more shares that, at least in part, grant the shareholder the right to receive the fee (e.g., an insurance premium paid on a monthly basis) that a party pays under a coverage-denial contract that forms at least part of the asset.

Next, referring to a step 150, the computing apparatus automatically makes an offer to transfer at least one share of the asset. For example, the computing apparatus may cause the offer generated at the step 150 to be published in an online investment market place, or may send the offer directly to potential acquirers, for example, investment houses.

Then, referring to a step 152, the computing apparatus automatically receives an acceptance of the offer to transfer at least one share of the asset. For example, the computing apparatus may receive the acceptance from the accepting party in an email, text, voice communication, or other electronic communication received via the internet or a phone system.

But if the computing apparatus instead “decides” at the step 144 to solicit an offer to acquire at least one share of the asset instead of offering to transfer at least one share of the asset, then, referring to the step 148, the computing apparatus automatically generates an invitation to make an offer to acquire at least one share of the asset, where the generated invitation may be in any suitable format such as electronic or paper format. For example, the computing apparatus may generate an invitation to make an offer to acquire one or more shares of the right of a party under a coverage-denial contract of the asset to receive the fees paid by another party to the coverage-denial contract.

Next, referring to a step 154, the computing apparatus automatically solicits an offer to acquire at least one share of the asset. For example, the computing apparatus may cause the invitation generated at the step 148 to be published in an online investment market place, or may send the offer directly to potential acquirers for example, investment houses. Furthermore, the invitation may solicit competitive bidding (secret or public) to acquire one or more shares of the asset.

Then, referring to a step 156, the computing apparatus automatically receives an offer to acquire at least one share of the asset. For example, the computing apparatus may receive the offer from the offering third party in an email, text, voice communication, or other electronic communication via the internet or a phone system. If the computing apparatus receives offers in the forms of bids, then the computing apparatus may automatically track the bids by, e.g., the bid amount and the number of shares bid on.

Next, referring to a step 158, the computing apparatus automatically generates an acceptance of the received offer to acquire at least one share of the asset, where the generated acceptance may be in any suitable format such as electronic or paper format.

Then, referring to a step 160, the computing apparatus automatically accepts the offer to acquire at least one share of the asset. For example, the computing apparatus may send the acceptance generated at the step 158 via email to the third party who made the best offer.

Next, after whichever of the step 152 and the step 160 that the computing apparatus performs, referring to a step 162, the computing apparatus automatically receives consideration from the acquirer for transferring the at least one share of the asset. For example, the computing apparatus may receive an electronic payment from the credit card, debit card, or bank account of the acquirer. And if the acquirer is obligated to make one or more future payments (e.g., monthly installments), then the computing apparatus may also receive these payments in due course.

Then, referring to a step 164, the computing apparatus transfers the at least one share of the asset to the acquirer. For example, the computing apparatus may generate and send to the acquirer a share certificate that memorializes the details of the transfer.

Still referring to FIG. 10, alternate embodiments of the method represented by the flow diagram 140 are contemplated. For example, the method may include steps in addition to the steps 142-164, may omit one or more of the steps 142-164, or may modify one or more of these steps. Furthermore, the computing apparatus may perform one or more of the steps 142-164 other than automatically, or in response to human or other intervention; or another type of apparatus, or even a human, may perform one or more of these steps. Moreover, the computing apparatus may automatically repeat one or more of the steps 142-164 as appropriate to make multiple offers, multiple solicitations of offers, multiple acceptances, or multiple share transfers.

FIG. 11 is a flow diagram 170 of a method for forming an asset, such as the asset 130 of FIG. 9, according to an embodiment.

Referring to a step 172, a computing apparatus automatically forms an asset, such as the asset 130 of FIG. 9, that includes at least one coverage-denial contract (e.g., the coverage-denial contract 132 of FIG. 9), and that may also include at least one other instrument (e.g., such as the other instruments 134 of FIG. 9). For example, the computing apparatus may automatically generate the documents that need to be filed to form the asset legally, and then may automatically file these documents with the proper entity or entities (e.g., a government agency such as the Securities and Exchange Commission (SEC)) to form the asset. Such documents may include a description of the asset, which description the computing apparatus may generate as described above in conjunction with step 122 of FIG. 8 and step 142 of FIG. 10. And where the asset is to include more than one item (e.g., a coverage-denial contract and another instrument), then the computing apparatus may form the asset by pooling, bundling, or otherwise combining these items into the asset.

Next, referring to a step 174, the computing apparatus determines whether the formed asset is to be collateralized. If the computing apparatus determines that the formed asset is to be collateralized, then it proceeds to a step 176; otherwise, the computing apparatus proceed to a step 178.

Referring to the step 176, the computing apparatus automatically collateralizes the formed asset. Examples of collateralizing the formed asset include acquiring property such as bonds or other securities, and pledging this property as collateral, e.g., against a failure of a payment obligation on at least one of the items (e.g., one or more coverage-denial contracts and one or more other instruments) that forms the asset. Or, the computing apparatus may make the pledged property a part of the asset.

Alternatively, referring to the step 178, if the computing apparatus determines that the formed asset is not to be collateralized, then the computing apparatus determines whether the formed asset is to be over-collateralized. If the computing apparatus determines that the formed asset is to be over-collateralized, then it proceeds to a step 180; otherwise, the computing apparatus ends the process such that the formed asset is neither collateralized nor over-collateralized.

Referring to the step 180, the computing apparatus automatically over-collateralizes the formed asset. Examples of over-collateralizing the formed asset include acquiring property such as bonds or other securities, and pledging this property as collateral, e.g., against a failure of a payment obligation on at least one of the items (e.g., one or more coverage-denial contract and one or more other instruments) that form the asset, where the value of the property (or its payout) is greater than the value (or payout) of the asset items. Or, the computing apparatus may make the pledged property a part of the asset.

At the end of the asset-formation method, the formed asset is uncollateralized, collateralized, or over-collateralized.

Still referring to FIG. 11, alternate embodiments of the method represented by the flow diagram 170 are contemplated. For example, the method may include steps in addition to the steps 172-180, may omit one or more of the steps 172-180, or may modify one or more of these steps. Furthermore, the computing apparatus may perform one or more of the steps 172-180 other than automatically, or in response to human or other intervention; or another type of apparatus, or even a human, may perform one or more of these steps.

Referring again to FIGS. 8-11, to further reduce the risk profile, and to further increase the attractiveness, of an investment beyond the risk profile and attractiveness of a single asset such as the asset 130 of FIG. 9, a computing apparatus can automatically form an entity that includes one or more assets, such as one or more of the asset 130 of FIG. 9 or of a similar asset.

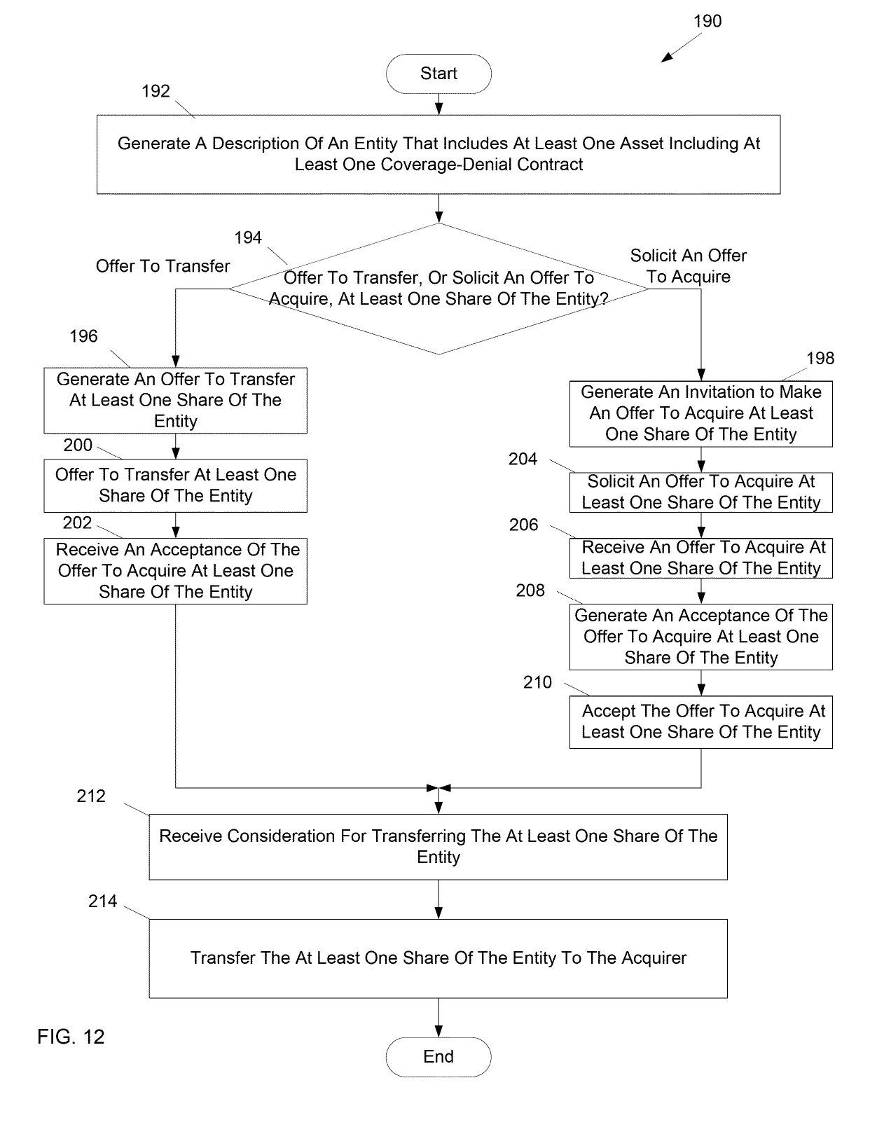

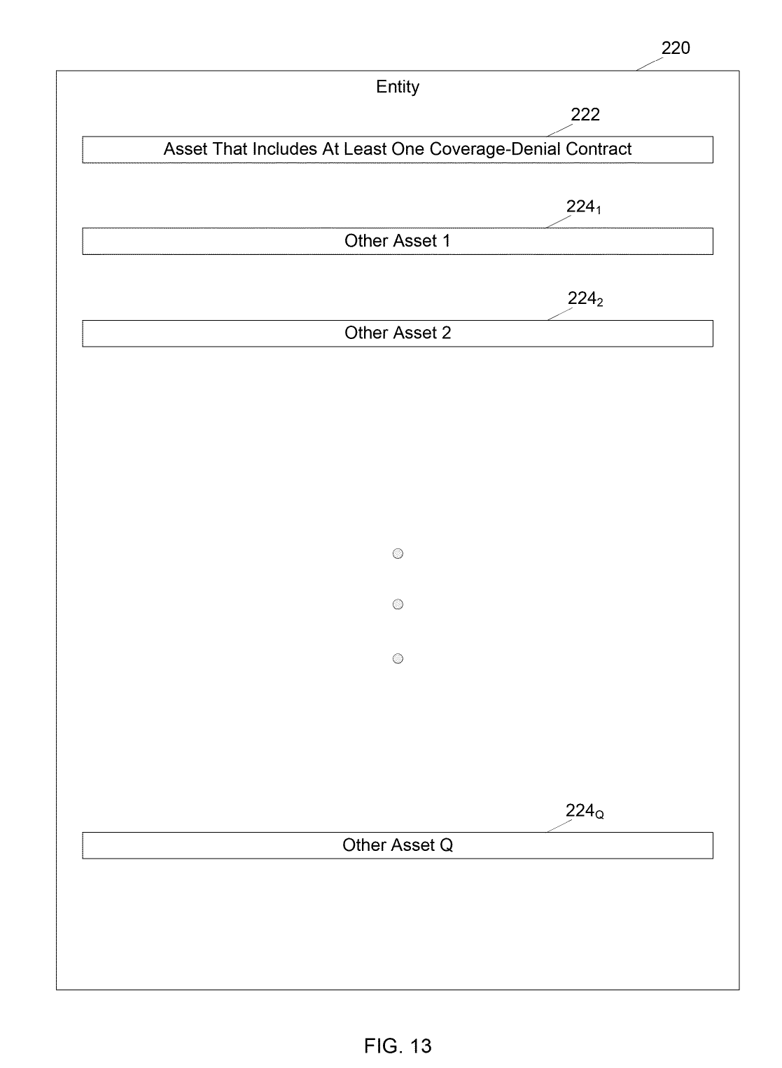

FIG. 12 is a flow diagram 190 of a method for generating a description of an entity that includes at least one an asset (e.g., the asset 130 of FIG. 9) that includes at least one coverage-denial contract (e.g., the coverage-denial contract 132 of FIG. 9 or the coverage-denial contract 50 of FIG. 4), and for managing a transfer of one or more shares of the entity, according to an embodiment. As described below in conjunction with FIGS. 13-15, the described entity may be, e.g., a pass-through entity, a special-purpose entity, or an entity that includes tranches. Furthermore, hereinafter, terms such as “transferring the entity,” “selling the entity,” “transferring shares in the entity,” and “selling shares in the entity” refer to the transfer/sale of one or more shares of one or more rights or obligations under the assets that form the entity to one or more third parties, where the transfer may, or may not, be for return consideration. For example, shares of the entity, which include shares of the right to receive a fee under an asset that forms part of the entity, may be sold to one or more investors. Moreover, the entity may also include one or more assets that do not include a coverage-denial contract.

Referring to a step 192, a computing apparatus automatically generates a description of an entity that includes at least one asset (e.g., the asset 130 of FIG. 9) including at least one coverage-denial contract (e.g., the coverage-denial contract 132 of FIG. 9 or the coverage-denial contract 50 of FIG. 4), and that may include at least one other asset, according to an embodiment. The computing apparatus may generate the description of the entity in any suitable format, such as in electronic format or on paper via a printer coupled to, or part of, the computing apparatus.

Next, referring to a step 194, the computing apparatus automatically determines whether to offer at least one share of the entity for transfer or to solicit an offer to acquire at least one share of the entity.

If, at the step 194, the computing apparatus “decides” to offer at least one share of the entity for transfer, then the computing apparatus proceeds to a step 196; otherwise, the computing apparatus proceeds to a step 198.

Referring to the step 196, the computing apparatus automatically generates an offer to transfer at least one share of the entity, where the generated offer may be in any suitable format such as paper or electronic format. For example, the computing apparatus may generate an offer to transfer to a third party one or more shares that, at least in part, grant the shareholder the right to receive the fee (e.g., a coverage-denial insurance premium paid on a monthly basis) that a party pays under a coverage-denial contract that forms at least part of at least one asset of the entity.

Next, referring to a step 200, the computing apparatus automatically makes an offer to transfer at least one share of the entity. For example, the computing apparatus may cause the offer generated at the step 196 to be published in an online investment market place, or may send the offer directly to potential acquirers, for example, investment houses.

Then, referring to a step 202, the computing apparatus receives an acceptance of the offer to acquire at least one share of the entity. For example, the computing apparatus may receive the acceptance from the accepting party in an email, text, voice communication, or other electronic communication received via the internet or a phone system.

But if the computing apparatus instead “decides” at the step 194 to solicit an offer to acquire at least one share of the entity instead of offering to transfer at least one share of the entity, then, referring to the step 198, the computing apparatus automatically generates an invitation to make an offer to acquire at least one share of the entity, where the generated invitation may be in any suitable format such as electronic or paper format. For example, the computing apparatus may generate an invitation to make an offer to acquire one or more shares of the right of a party of a coverage-denial contract of an asset that forms part of the entity to receive the fee (e.g., coverage-denial insurance premiums paid on a monthly basis) paid by another party.

Next, referring to a step 204, the computing apparatus automatically solicits an offer to acquire at least one share of the entity. For example, the computing apparatus may cause the invitation generated at the step 198 to be published in an online investment market place, or may send the offer directly to potential acquirers, for example, investment houses. Furthermore, the invitation may solicit competitive bidding (secret or public) to acquire one or more shares of the entity.

Then, referring to a step 206, the computing apparatus receives an offer to acquire at least one share of the entity. For example, the computing apparatus may receive the offer from the offering third party in an email, text, voice communication, or other electronic communication via the internet or a phone system.

Next, referring to a step 208, the computing apparatus automatically generates an acceptance of the received offer to acquire at least one share of the entity, where the generated acceptance may be in any suitable format such as electronic or paper format.

Then, referring to a step 210, the computing apparatus automatically accepts the offer to acquire at least one share of the entity. For example, the computing apparatus may send the acceptance generated at the step 208 via email to the third party who made the best offer.

Next, after whichever of the step 202 and the step 210 that the computing apparatus performs, referring to a step 212, the computing apparatus automatically receives consideration from the acquirer for transferring the at least one share of the entity. For example, the computing apparatus may receive an electronic payment from the credit card, debit card, or bank account of the acquirer. And if the acquirer is obligated to make one or more future payments (e.g., monthly installments), then the computing apparatus may also receive these payments in due course.

Then, referring to a step 214, the computing apparatus automatically transfers the at least one share of the entity to the acquirer. For example, the computing apparatus may generate and send to the acquirer a transfer agreement or a share certificate that memorializes the details of the transfer.

Still referring to FIG. 12, alternate embodiments of the method represented by the flow diagram 190 are contemplated. For example, the method may include steps in addition to the steps 192-214, may omit one or more of the steps 192-214, or may modify one or more of these steps. Furthermore, the computing apparatus may perform one or more of the steps 192-214 other than automatically, or in response to human or other intervention; or another type of apparatus, or even a human, may perform one or more of these steps. Moreover, the computing apparatus may automatically repeat one or more of the steps 192-214 as appropriate to make multiple offers, multiple solicitations of offers, multiple acceptances, or multiple share transfers.

FIG. 13 is a diagram of an entity 220 that includes at least one asset 222 that includes at least one coverage-denial contract, according to an embodiment. For example, the asset 222 may be the same as, or similar to, the asset 130 of FIG. 9, and the coverage-denial contract may be similar to, or the same as, the coverage-denial contract 50 of FIG. 4 or the coverage-denial contract 132 of FIG. 9. And in addition to the at least one asset 222, the entity 220 may include at least one other asset 224₁-224_{Q}, where Q≧1.

Examples of the entity 220 include a pass-through entity, a special-purpose entity, or a tranched entity.

An embodiment of a pass-through entity is an entity in which the income that the entity generates flows through to the investor shareholders such that the entity itself is not taxed (only the investor shareholders are taxed on the income that they receive from the entity).

An embodiment of a special-purpose entity (sometimes called a “special-purpose vehicle”) is an entity set up, e.g., to isolate a firm that owns the entity from financial risk, to hide debt or to hide ownership of the assets that form the entity, or to obscure relationships between different entities.

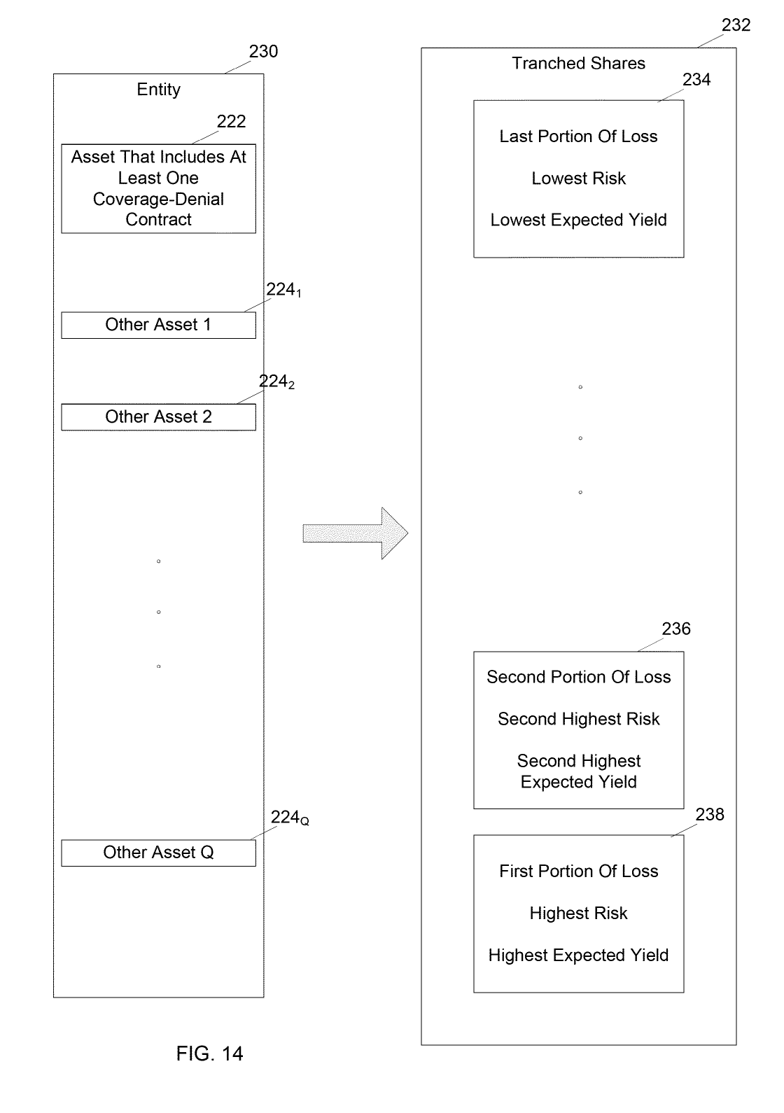

And an embodiment of a tranched entity is described below in conjunction with FIG. 14.

FIG. 14 is a diagram of a tranched entity 230, according to an embodiment in which the tranched entity includes the same asset(s), and thus has the same asset structure, as the entity 220 of FIG. 13. That is, like the entity 220, the entity 230 includes the asset 222, and may include at least one other asset 224₁-224_{Q}, according to an embodiment.

The shares 232 of the entity 230 are tranched; that is, the shares are divided into different classes (only classes 234, 236, and 238 are shown, although the entity may include more or fewer than three share classes) each having a respective risk profile, a respective return profile, and a respective share price. For example, tranching allows the entity 230 to have different classes of shares, at least some of which may have a more attractive risk profile than the average risk profile of the underlying asset 222, and possibly one or more other assets 224, that form the entity.

In an example, the entity 230 has three and only three classes 234, 236, and 238 of shares, and has a basis of US$90,000,000. The class 234 shares, as a group, absorb the last 33⅓% of any losses (relative to the basis) that the entity 230 experiences, and receive 20% of any profit that the entity earns. The class 236 shares, as a group, absorb the next 33⅓% of any losses that the entity 230 experiences, and receive 35% of any profit that the entity earns. And the class 238 shares, as a group, absorb the first 33⅓% of any losses that the entity 230 experiences, and receive 45% of any profit that the entity earns.

Continuing with this example regarding the sharing of a loss that the entity 230 suffers, if, for example, the entity loses, e.g., via erosion of the asset values, US$25,000,000, then the group 238 shares absorb this entire loss, and the groups 234 and 236 shares suffer no loss. If the entity 230 loses US$50,000,000, then the group 238 shares absorb US$30,000,000 of this loss, the group 236 shares absorb US$20,000,000 of this loss, and the group 234 shares suffer no loss. And if the entity 230 loses US$70,000,000, then the shares of the groups 238 and 236 each absorb US$30,000,000 of this loss (for a total loss of US$60,000,000 absorbed by the groups 238 and 236), and the group 234 shares absorb only US$10,000,000 of this loss.

And continuing with the above example regarding the entity 230 returning a profit, if, for example, the entity returns US$10,000,000, then the class 238 shares, as a group, are entitled to US$4,500,000, the class 236 shares are entitled to US$3,500,000, and the class 234 shares are entitled to US$2,000,000.

Still referring to FIG. 14, alternate embodiments of the tranched entity 230 are contemplated. For example, the entity 230 may be tranched such that it includes at least one class of shares having both a lower risk profile and a higher return profile; for example, such a class of shares may be considered a preferred class of shares that are sold to institutional investors (e.g., a pension fund) who purchase at least a specified minimum number of these shares.

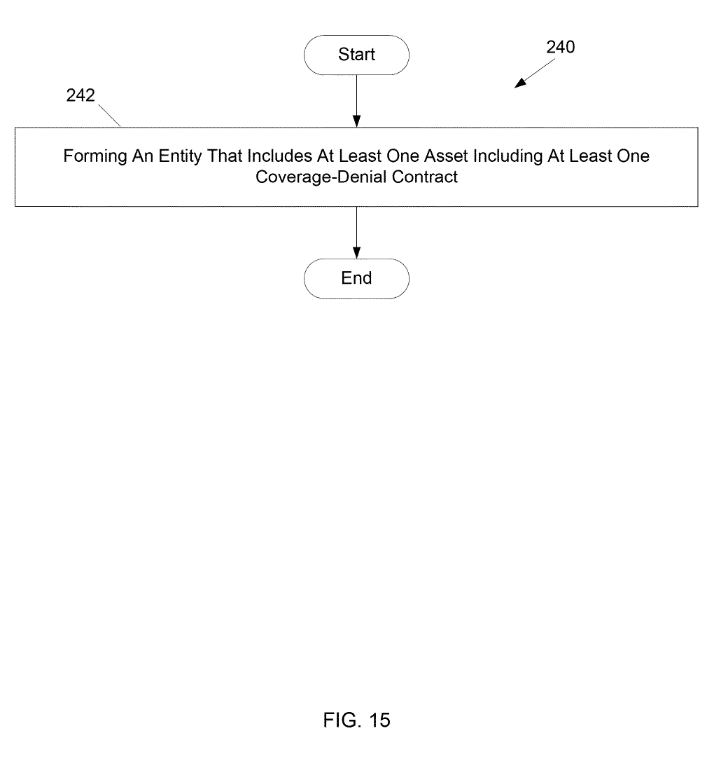

FIG. 15 is a flow diagram 240 of a method for forming an entity that includes at least one asset including at least one coverage-denial contract, according to an embodiment.

Referring to a step 242, a computing apparatus automatically forms an entity (e.g., the entity 220 of FIG. 13 or the tranched entity 230 of FIG. 14) that includes at least one asset (e.g., the asset 130 of FIG. 9 or the asset 222 of FIGS. 13 and 14) that includes at least one coverage-denial contract (e.g., the coverage-denial contract 50 of FIG. 4 or the coverage-denial contract 132 of FIG. 9). For example, the computing apparatus may automatically generate the documents that need to be filed to form the entity legally, and then may automatically file these documents with the proper authority or authorities (e.g., a government agency such as the Securities and Exchange Commission (SEC)) to form the entity. Such documents may include a description of the entity, which description the computing apparatus may generate as described above in conjunction with step 122 of FIG. 8 or step 142 of FIG. 10. And where the entity is to include more than one asset, then the computing apparatus may form the entity by pooling, bundling, or otherwise combining these assets into the entity. Furthermore, the computing apparatus may collateralize the entity in a manner similar to that described above in conjunction with the flow diagram 170 of FIG. 11.

Still referring to FIG. 15, alternate embodiments of the method represented by the flow diagram 240 are contemplated. For example, the method may include steps in addition to the step 242, or may modify this step. Furthermore, the computing apparatus may perform the step 242 other than automatically, or in response to human or other intervention; or another type of apparatus, or even a human, may perform this step.

FIG. 16 is a block diagram of a computing apparatus 250 that can automatically perform one or more steps of each of the methods described above in conjunction with FIGS. 2-3, 5-8, 10-12, and 15, according to an embodiment.

The computing apparatus 250 includes computing circuitry 252, which may be, or which may include, at least one microprocessor or at least one microcontroller. The computing circuitry 252 includes circuitry for performing various functions, such as executing specific software or implementing specific firmware to perform specific calculations or to control the computing apparatus 250 to provide a desired functionality; or, the computing circuitry may perform various functions solely in hardware, or in a combination or sub-combination of software, firmware, and hardware.

Furthermore, the computing apparatus 250 includes one or more input devices 254, such as a keyboard, mouse, touch screen, audible or voice-recognition component, and so on, coupled to the computing circuitry 252 to allow, e.g., an operator or another computer system, to interface with the other components of the computing apparatus.

Moreover, the computing apparatus 250 also includes one or more output devices 256 coupled to the computing circuitry 252, where the output devices can include a printer, a video display, an audio device (e.g., a speaker), a data-output device (e.g., a cable) and so on.

In addition, the computing apparatus 250 also includes one or more data-storage devices 258 that are coupled to the computing circuitry 252 to store data or to retrieve data from storage media (not shown). Examples of typical data-storage devices 258 include magnetic disks, FLASH memory, EPROMs, EEPROMS, and other types of solid-state memory, tape drives, optical disks like compact disks and digital versatile disks (DVDs), and so on.

Furthermore, the computing apparatus 250 may be part of a local-area network (LAN), and the computing circuitry 252 (or perhaps one or more other components of the computing apparatus) may be coupled to the internet directly or via the LAN, and, therefore, may be configured to send data to a remote receiver via the internet, and may be configured to receive data from a remote source via the internet.

From the foregoing it will be appreciated that, although specific embodiments have been described herein for purposes of illustration, various modifications may be made without deviating from the spirit and scope of the disclosure. Furthermore, where an alternative is disclosed for a particular embodiment, this alternative may also apply to other embodiments even if not specifically stated.

While various aspects and embodiments have been disclosed herein, other aspects and embodiments will be apparent to those skilled in the art from the detailed description provided herein. The various aspects and embodiments disclosed herein are for purposes of illustration and are not intended to be limiting, with the true scope and spirit being indicated by the following claims.

1. A method, comprising:
with a computing apparatus, automatically determining a risk that one or more insurers will deny coverage for treating one or more insured for one or more conditions; and
with the computing apparatus, automatically calculating, in response to a determined risk, a fee for taking a respective action for each instance of at least one of the one or more insurers denying coverage for treating at least one of the one or more insured.

2.-35. (canceled)

36. The method of claim 1 wherein taking the respective action for each instance of at least one of the one or more insurers denying coverage for treating at least one of the one or more insured includes paying an amount to a beneficiary.

37. The method of claim 36 wherein paying the amount to the beneficiary includes reimbursing the beneficiary for the amount.

38.-46. (canceled)

47. The method of claim 1 wherein taking the respective action for each instance of at least one of the one or more insurers denying coverage for treating at least one of the one or more insured includes taking legal action against the at least one of the one or more insurers for payment of at least part of a cost of treating the at least one of the one or more insured.

48. (canceled)

49. The method of claim 1, further comprising:
with the computing apparatus, receiving information about at least one of the one or more insurers; and
wherein determining the risk includes determining the risk in response to the information.

50. The method of claim 49 wherein the information includes a coverage-denial rate of the at least one of the one or more insurers.

51. The method of claim 49 wherein the information includes information about whether the at least one of the one or more insurers approved coverage for treating at least one of the one or more insured before the at least one of the one or more insured was treated.

52.-57. (canceled)

58. The method of claim 1, further comprising:
with the computing apparatus, receiving information about one or more medical treatments;
wherein determining the risk includes determining the risk in response to the information; and
wherein treating the one or more insured includes administering at least one of the one or more medical treatments to a least one of the one or more insured.

59.-63. (canceled)

64. The method of claim 49 wherein:
the information includes information about a respective denial rate of at least one of the one or more insurers for coverage of one or more medical treatments; and
treating the one or more insured includes administering at least one of the one or more medical treatments to at least one of the one or more insured.

65.-72. (canceled)

73. The method of claim 1, further comprising:
with the computing apparatus, receiving information about one or more coverage-denial rates for one or more providers of one or more medical treatments;
wherein determining the risk includes determining the risk in response to the information; and
wherein treating the one or more insured includes at least one of the one or more providers administering at least one of the one or more medicals treatment to at least one of the one or more insured.

74.-75. (canceled)

76. The method of claim 1, further comprising generating a coverage-denial contract that includes at least one recital that a party is to pay the fee and that another party is to take the respective action for each instance of at least one the one or more insurers denying coverage for treating at least one of the one or more insured for at least one of the one or more conditions.

77. The method of claim 76 wherein the coverage-denial contract includes an insurance policy.

78.-147. (canceled)

148. An apparatus, comprising:
a determiner module configured to determine automatically a risk that one or more insurers will deny coverage for treating one or more insured for one or more conditions; and
a calculator module configured to calculate automatically, in response to a determined risk, a fee for taking a respective action for each instance of at least one of the one or more insurers denying coverage for treating at least one of the one or more insured.

149. The apparatus of claim 148 wherein the determiner module is configured to determine the risk for a coverage time period.

150.-159. (canceled)

160. The apparatus of claim 148 wherein the determiner module is configured to determine the risk before treating at least one of the one or more insured.

161. The apparatus of claim 148 wherein the determiner module is configured to determine the risk after treating all of the one or more insured.

162. The apparatus of claim 148 wherein the determiner module is configured to determine a probability that at least one of the one or more insurers will deny coverage for treating at least one of the one or more insured for at least one of the one or more conditions.

163.-175. (canceled)

176. The apparatus of claim 148 wherein the one or more insured are each insured under one or more insurance policies issued by at least one of the one or more insurers.

177.-178. (canceled)

179. The apparatus of claim 148 wherein at least one of the one or more conditions includes a medical condition.

180.-181. (canceled)

182. The apparatus of claim 148 wherein the fee includes an insurance premium.

183.-244. (canceled)

245. The apparatus of claim 148, further comprising a generator module configured to generate a coverage-denial contract that includes:
at least one recital that a party is to pay the fee and that another party is to take the respective action for each instance of at least one of the one or more insurers denying coverage for treating at least one of the one or more insured for at least one of the one or more conditions; and
at least one recital of an event that must occur before the other party is obligated to take the respective action.

246.-249. (canceled)

250. The apparatus of claim 148, further comprising a generator module configured to generate:
a coverage-denial contract that includes at least one recital that a party is to pay the fee and that another party is to take the respective action for each instance of at least one of the one or more insurers denying coverage for treating at least one of the one or more insured for at least one of the one or more conditions; and
a description of an asset that includes the coverage-denial contract.

251.-260. (canceled)

261. The apparatus of claim 250 wherein the generator module is configured to generate an offer to sell the asset.

262.-263. (canceled)

264. The apparatus of claim 148, further comprising a generator module configured to generate:
a coverage-denial contract that includes at least one recital that a party is to pay the fee and that another party is to take the respective action for each instance of at least one of the one or more insurers denying coverage for treating at least one of the one or more insured for at least one of the one or more conditions; and
an offer to sell the coverage-denial contract.

265.-294. (canceled)

295. An apparatus, comprising:
means for automatically determining a risk that one or more insurers will deny coverage for treating one or more insured for one or more conditions; and
means for automatically calculating, in response to a determined risk, a fee for taking a respective action for each instance of at least one of the one or more insurers denying coverage for treating at least one of the one or more insured.

296.-355. (canceled)

356. The apparatus of claim 295, further comprising:
means for receiving information about one or more facilities administering at least part of each of one or more medical treatments;
wherein the means for determining includes means for determining the risk in response to the information; and
wherein treating the one or more insured includes administering at least one of the one or more medical treatments to at least one of the one or more insured.

357. The apparatus of claim 295, further comprising:
means for receiving information about a respective success rate of each of one or more medical treatments;
wherein the means for determining includes means for determining the risk in response to the information; and
wherein treating the one or more insured includes administering at least one of the one or more medical treatments to at least one of the one or more insured.

358.-441. (canceled)

442. A non-transitory computer-readable medium comprising:
stored instructions that, when executed by at least one computing apparatus, cause the at least one computing apparatus
to determine automatically a risk that one or more insurers will deny coverage for treating one or more insured for one or more conditions; and
to calculate automatically, in response to a determined risk, a fee for taking a respective action for each instance of at least one of the one or more insurers denying coverage for treating at least one of the one or more insured.

443.-507. (canceled)

508. The non-transitory computer-readable medium of claim 442 wherein:
the stored instructions, when executed by at least one computing apparatus, cause the at least one computing apparatus
to receive information about whether at least one of the one or more insured will need follow-up care after being treated for at least one of the one or more conditions, and, if the at least one insured does need follow-up care, information about the likelihood that at least one of the one or more insures will cover the follow-up care if the one or more insures denies the coverage for treating the at least one of the one or more insured for the at least one of the one or more conditions, and
to determine the risk in response to the information.

509. The non-transitory computer-readable medium of claim 442 wherein:
the stored instructions, when executed by at least one computing apparatus, cause the at least one computing apparatus
to receive information about one or more insurance policies issued by at least one of the one or more insurers, and
to determine the risk in response to the information; and
at least one of the one or more insured is insured under at least one of the one or more insurance policies.

510.-588. (canceled)
